(19) United States
(12) Patent Application Publication
(10) Pub. No.: US 2014/0250390 A1
(43) Pub. Date: Sep. 4, 2014

(54) METHOD OF CONFIGURING ICONS IN A WEB BROWSER INTERFACE, AND ASSOCIATED DEVICE AND COMPUTER PROGRAM PRODUCT

(71) Applicants: Andrew Holmes, London (GB); Barney Morrison-Lyons, London (GB); Kam Young, London (GB)

(72) Inventors: Andrew Holmes, London (GB); Barney Morrison-Lyons, London (GB); Kam Young, London (GB)

(73) Assignee: FIRESTORM LAB LIMITED, London (GB)

(21) Appl. No.: 14/123,613

(22) PCT Filed: Jun. 6, 2012
(86) PCT No.: PCT/GB2012/051268

§ 371 Date: May 9, 2014

(30) Foreign Application Priority Data
Jun. 3, 2011 (GB) 1109339.0
Jul. 5, 2011 (GB) 1111461.8

(51) Int. Cl. G06F 3/0481; G06F 3/0482; G06F 3/0483

(52) U.S. Cl. CPC G06F 3/04817; G06F 3/0483; G06F 3/0482
USPC 715/760

(57) ABSTRACT

There is provided a method of configuring icons in a web browser interface provided by a web browser program running on a computer, the method comprising the steps of: (i) providing screen output from the computer to a screen; (ii) providing the web browser interface in the screen output; (iii) providing in the web browser interface a docking area for icons, wherein the docking area is operable to receive website icons, each website icon being selectable to navigate to a respective website in the web browser interface.

### BACKGROUND OF THE INVENTION

1. Field of the Invention

The field of the invention relates to methods of configuring icons in web browser interfaces, and to associated devices and computer program products.

2. Technical Background

Well-known web browsers present a problem with regard to viewing and navigating in a convenient way, especially if the user wants to save a large amount of website addresses. Storing lists of websites in a drop-down list of “Bookmarks” or “Favourites” is known, e.g. in the Safari browser, but finding and selecting a desired website from such a list is cumbersome when it contains for example over a hundred entries. In addition, conventional browsers are for accessing remotely-stored websites, whereas locally stored applications must be accessed in a different way.

3. Discussion of Related Art

Here is a brief history of web browsers.

In 1993, browser software was innovated with the release of Mosaic (later Netscape), “the world's first popular browser”, which made the World Wide Web system easy to use and more accessible to the average person. This browser sparked the internet boom of the 1990s. The introduction of Mosaic in 1993—one of the first graphical web browsers—led to an explosion in web use. Netscape released the Mosaic-influenced Netscape Navigator in 1994, which quickly became the world's most popular browser, accounting for 90% of all web use at its peak.

Microsoft responded with its Internet Explorer in 1995, also heavily influenced by Mosaic, initiating the industry's first browser war. Bundled with Windows, Internet Explorer gained dominance in the web browser market; Internet Explorer usage share peaked at over 95% by 2002.

Opera debuted in 1996; although it has never achieved widespread use.

In 1998, Netscape launched what was to become the Mozilla Foundation in an attempt to produce a competitive browser using the Open Source software model. That browser would eventually evolve into Firefox, which developed a respectable following while still in the beta stage of development; shortly after the release of Firefox 1.0 in late 2004, Firefox (all versions) accounted for 7% of browser use.

Apple's Safari had its first beta release in January 2003. The most recent major entrant to the browser market is Google's Chrome, first released in September 2008.

### SUMMARY OF THE INVENTION

According to a first aspect of the invention, there is provided a method of configuring icons in a web browser interface provided by a web browser program running on a computer, the method comprising the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

The method may be one further comprising a method of creating icons in a web browser interface provided by a web browser program running on a computer, the method further comprising the steps of:

(iv) providing an icon-creation icon in the web browser interface, wherein selection of the icon-creation icon when a website is displayed prompts a user to save an icon corresponding to the website and to choose the corresponding icon.

The method may be one wherein the corresponding icon is a library icon.

The method may be one wherein the corresponding icon is a part of a saved photo.

The method may be one wherein the corresponding icon is an icon identifiable by a search of the Web for a suitable icon.

The method may be one wherein the corresponding icon is a part of the displayed website.

The method may be one wherein the corresponding icon is a user-selected portion of a web page.

The method may be one wherein the corresponding icon is a user-selectable re-sizeable region of a web page.

The method may be one wherein the corresponding icon is a square or rectangular icon including any text, graphics or images present in a region of a web page.

The method may be one wherein anything a user would normally do within an operating system (“OS”) graphical user interface environment of the computer can be done within the web browser interface.

The method may be one wherein the web browser interface is pervasive.

The method may be one wherein the web browser interface is always-on.

The method may be one wherein the docking area is displayable integrally within the web browser interface.

The method may be one wherein the docking area is expandable to reveal hot link icons for all available websites.

The method may be one wherein the docking area icons are sized to be selectable with a fingertip when using a touch screen.

The method may be one wherein the web browser interface has expandable multiple docking areas within a browser window.

The method may be one wherein the web browser interface includes multiple selectable icon category tabs.

The method may be one wherein docking area icons are user-organisable into a plurality of categories, each category corresponding to an icon category tab.

The method may be one wherein a docking area and category tabs are operable to expand over a website screen output in response to user selection of an indication area, and to move back to a hidden position in response to user selection of an indication area. The method may be one wherein docking area icons are operable to be moved by the user by dragging them in to different positions in the docking area.

The method may be one wherein the web browser interface is operable to allow a user to customize which place on the screen the docking area is placed.

The method may be one wherein a place on the screen is a side of the screen, selectable to be either side of the screen.

The method may be one wherein web pages in websites are stored remotely from the computer.

The method may include the step of providing a navigation history output in the web browser interface, wherein the navigation history includes previously selected website icons.

The method may include the step of providing a back navigation icon, wherein selection of the back navigation icon selects a previously selected icon.

The method may be one wherein icons corresponding to websites are selectable for deletion from the docking area by dragging them away and dropping them in any other area of the web browser interface.

The method may be one wherein the web browser interface comprises an address field, the method including the step of presenting docking area icons to the user in response to a string entered by a user in the address field.

The method may be one wherein a set of icons in the docking area is operable to be distributed to other users.

The method may be one wherein the screen is a touch screen operable to receive touch screen input.

The method may be one wherein the web browser interface requires just two touches to either open any website or open any application with a corresponding icon in the docking area.

According to a second aspect of the invention, there is provided a computer web browser program product operable when running on a computer to configure icons in a web browser interface provided by the program running on the computer, the computer including a memory storing the computer web browser program product operable to perform the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

The computer web browser program product may be operable to perform the methods of any of the methods according to the first aspect of the invention.

According to a third aspect of the invention, there is provided a device comprising a processor, memory and a screen, the memory storing a computer web browser program product, the processor configured to run the computer web browser program product, the program operable to configure icons in a web browser interface provided by the program running on the device, wherein the computer web browser program product

(i) provides screen output to the screen;
(ii) provides the web browser interface in the screen output;
(iii) provides in the web browser interface a docking area for icons,
wherein the docking area is operable to receive website icons, each website icon being selectable to navigate to a respective website in the web browser interface.

The device may be operable to perform the methods of any of the methods according to the first aspect of the invention.

### BRIEF DESCRIPTION OF THE DRAWINGS

FIG. 1A shows an example of a landscape mode.

FIG. 1B shows an example of a portrait mode.

FIG. 2 shows an example of GUI Features.

FIG. 3 shows an example of Navigation icons.

FIG. 4 shows an example of an Auto-suggestion search, with one letter.

FIG. 5 shows an example of an Auto-suggestion search, with two letters.

FIG. 6 shows an example of a Plain interface.

FIG. 7 shows an example of Change tab name.

FIG. 8 shows an example of a Settings window.

FIG. 9 shows an example of a History menu.

FIG. 10 shows an example of Multiple pages of icons, first page.

FIG. 11 shows an example of Multiple pages of icons, second page.

FIG. 12 shows an example of Creating an icon using the main interface.

FIG. 13 shows an example of Selecting which part of the website to use as the icon.

FIG. 14 shows an example of an Icon creation successful prompt.

FIG. 15 shows an example of an icon being added to the docking pane.

FIG. 16 shows an example of Icon preferences.

FIG. 17 shows an example of Create icon from photo, select photo.

FIG. 18 shows an example of Create icon from photo, select part.

FIG. 19 shows an example of Create icon from photo, icon created.

FIG. 20 shows an example of Multiple ways to create an icon.

FIG. 21 shows an example of Active icons.

FIG. 22 shows an example of an Offline/Online indication on icon.

FIG. 23 shows an example of an Options menu, first level.

FIG. 24 shows an example of an Option menu, second level “Save”.

FIG. 25 shows an example of an Option menu, third level “Email”.

FIG. 26 shows an example of an Option menu, second level “Preferences”.

FIG. 27 shows an example of a Fake ID option.

FIG. 28 shows an example of Icon tabs.

FIG. 29 shows an example of Icon tabs with docking pane visible.

FIG. 30 shows an example of Regular tabs.

FIG. 31 shows an example of Search within web page or application.

FIG. 32 shows an example of a Search within web page or application, search in real-time with highlighted text.

FIG. 33 shows an example of Additional top-pane features.

FIG. 34 shows an example of a Sharing Communication.

FIG. 35 shows examples of Icon text illustrations.

### DETAILED DESCRIPTION

### Some Definitions

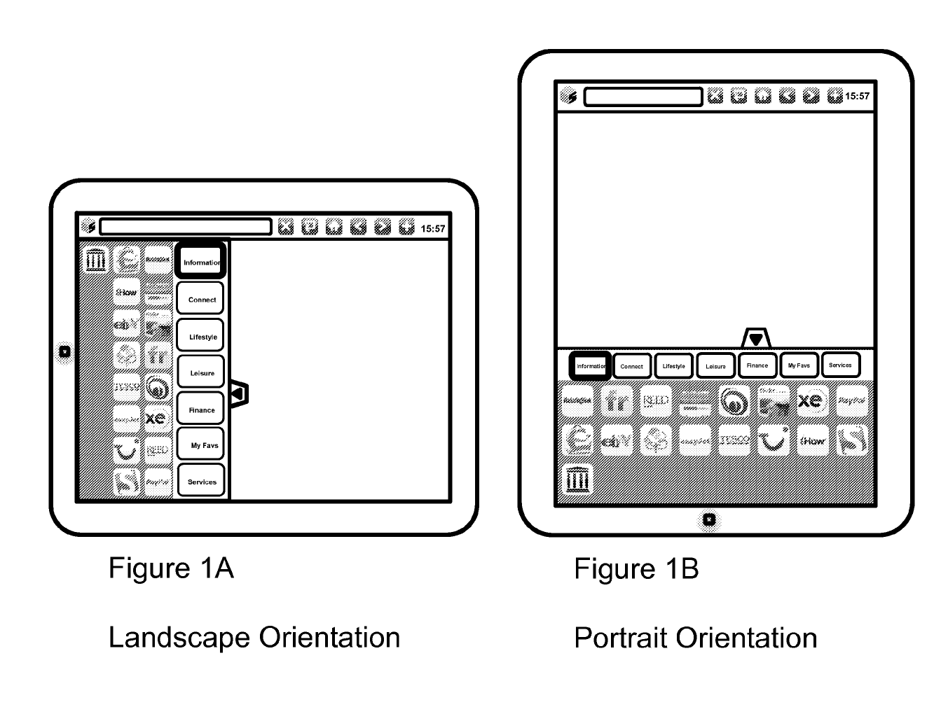

“Apps” or “Applications” are interchangeable terms describing application software, which is a computer program designed to perform a task, or to help a user to perform a task. “Browser area” indicates the area where the user can view an application or web site content. This term is interchangeable with “viewing area”. In the Figures, features are typically described in Landscape orientation (e.g. FIG. 1A) for consistency, however the interface displays equally well in Portrait (upright) mode as shown in FIG. 1B. In an example, the web browser program rotates the browser window from landscape to portrait (or vice versa) in response to a commensurate rotation of the device screen on which the screen output is displayed.

The terms ‘swipe’ and ‘tap’ are descriptions of user's finger or stylus gestures that control the graphical user interface (GUI) in which a touch-screen is deployed. ‘Dragging’ and ‘click’ describe the same operations, but using a computer mouse. ‘Swiping’ is when a user places one or more fingers on a touch-screen, or other touch-sensitive surface, and moves it in any direction. ‘Tapping’ is when a user quickly touches the screen at a specific point in order to trigger an operation.

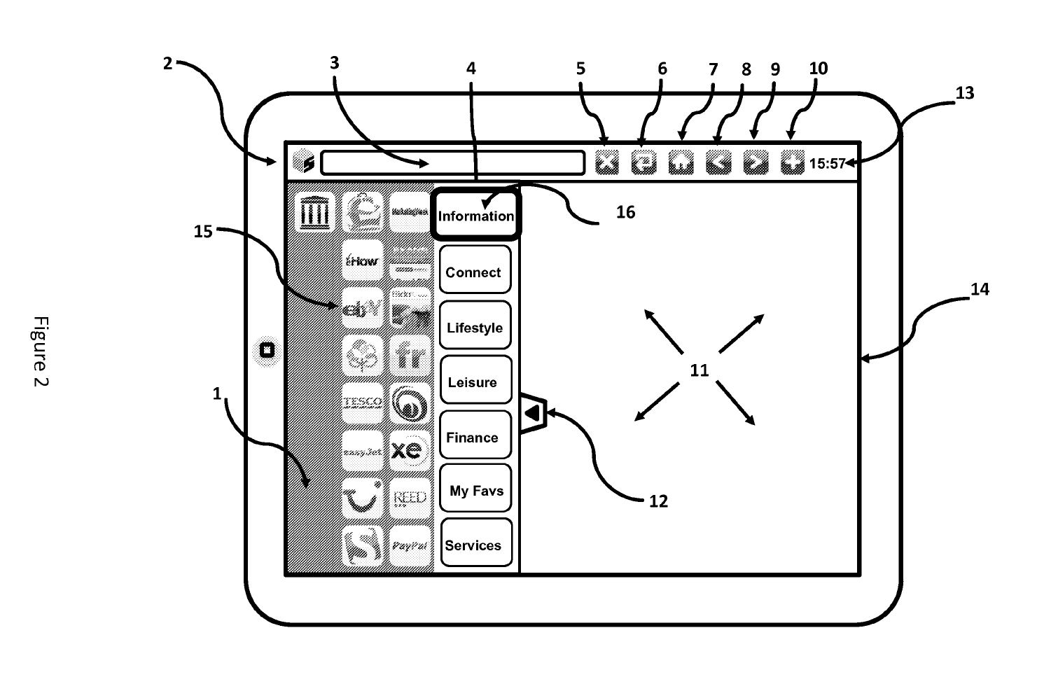

In FIG. 2, the entire interface is labelled as the interface 14. ‘Category tabs’ and ‘folders’ are interchangeable terms.

### Section 1 Top Level Features

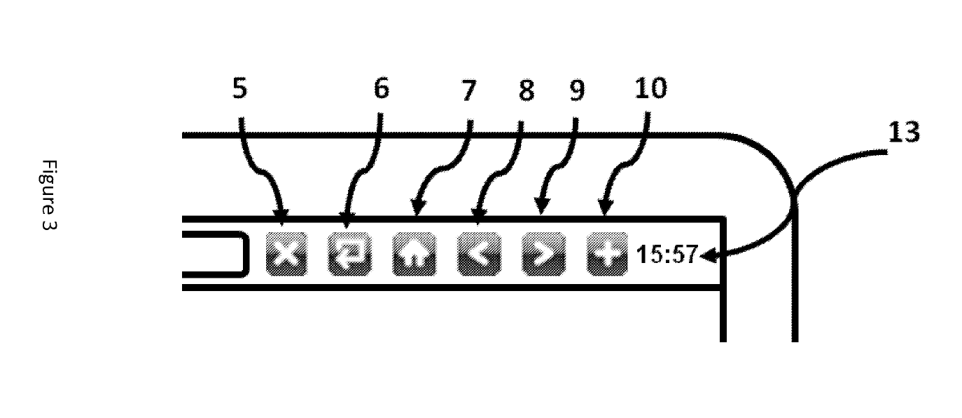

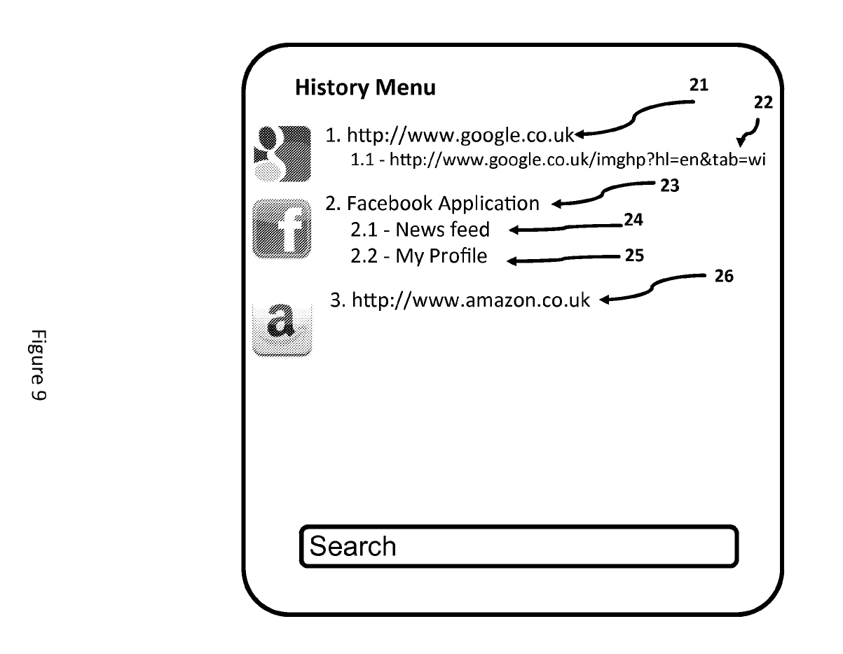

There is provided a computing device with a user operable graphical user interface in which local applications and remotely stored websites are presented to the user in the same “browser” window. The user interface is similar to a web browser but includes the possibility to run applications as well. In order to access content the user interface includes a docking area 1 for icons 15 representing apps or websites, as shown for example in FIG. 2. The system does not display a difference between websites and applications and thereby the navigation history, see e.g. FIG. 9, may be agnostic to whether a website or app is shown to the user. This enables the user to navigate back 8 and forth 9 (see e.g. FIGS. 2 and 3) between the history of viewed web pages and apps. The links in the user interface, to both websites or apps, are represented by icons.

In an example, there is provided a combined web browser & desktop graphical user interface suitable for touch-screen tablets, smart phones and mouse-operated personal computers. This relates to the field of software applications, graphical user interfaces, and web browsing technology. More particularly, it may combine the features of desktop applications, web browsers, and general graphical user interfaces with the use of customized icons as the main navigation feature.

1.1. A Graphical User Interface (GUI) Browser Designed for Tablet Computers or Other Computing Device in which the Browser Window is the Only GUI.

In an example, the browser is designed to be the only GUI and the browser window 11 is hence pervasive and always-on. Anything the user would normally do within the general purpose computer's operating system (“OS”) GUI environment can be done within the browser interface 14.

Eliminating the traditional OS GUI has a major user advantage. At the moment, with conventional devices, there are two distinct environments—first, when the user wants to navigate to and initiate an application (“App”) that is locally stored on the device, then the user is within the device's OS environment. That has a certain look and feel. But when the user wants to look outside of what is locally stored on the device by going to the web, then he has to open a web browser and the user experience is likely very different from that of the device's OS environment. This difference, or fracture, makes the conventional user experience far more complex than with the present approach.

1.2. Initiating or Opening a Locally Stored App from within the Browser Window

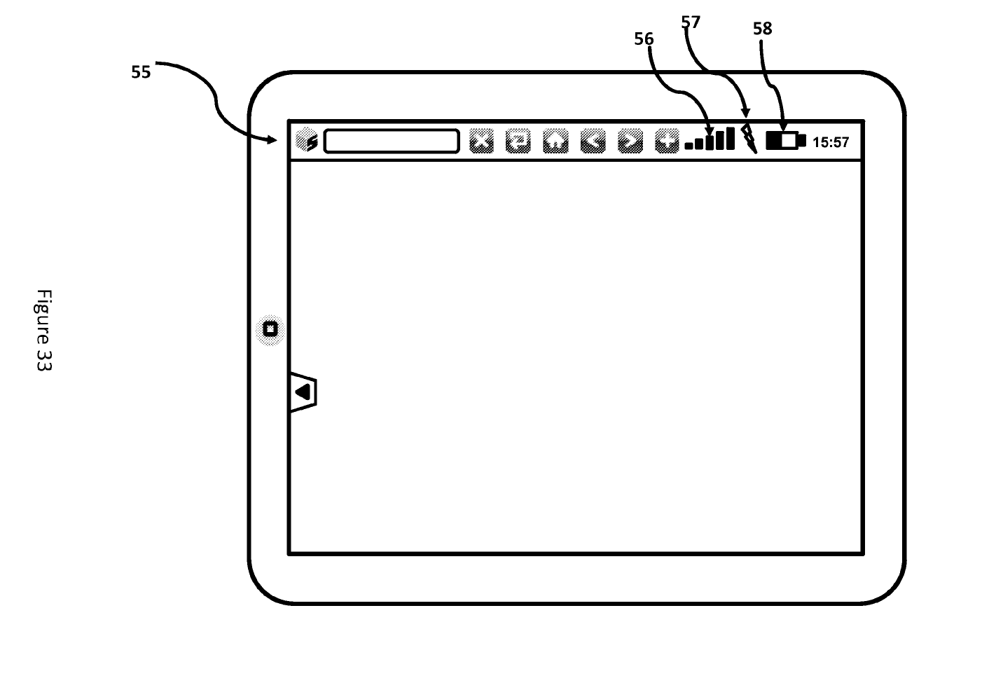

A specific instance of the high level idea of ‘Using the browser window as the only GUI environment’ is that the user does not need to leave the browser window 11 when they wish to open a locally stored App. That App can be opened from within the browser. Specifically, (see, e.g. FIG. 2) the browser includes a dedicated tabbed pane (or ‘docking area’) 1 that can be expanded to reveal hot link icons 15 for all available applications and stored websites; the icons 15 are typically square in shape and sized to be selectable with a fingertip when using a touch-screen device. When an application opens, it runs within the browser window 11—the browser window does not close, change focus, or minimise. The app will run in the full browser screen area excepting the top pane 55 (see e.g. FIG. 33).

### 1.3. Same User Experience for Opening an App as for Opening a Website.

In an example, within the interface 14 the user reaches and opens a website in just the same way as he or she would reach and open an application: in both cases, from within the always-open interface window 14. The application or website is displayed in the browser area 11. You touch the auto-hidden dock area 1 for the appropriate category; that causes the associated pane or docking area to expand, revealing all the icons in that category. The user then touches the appropriate icon. The process is the same whether the icon is for an application or a website.

Unifying the user's experience of navigating between websites and applications (i.e. the specific steps required to open a website and an application) makes the overall process faster and simpler to operate for a user. This is faster because there is never a need to open a separated dedicated browser, and then navigate away to the desired website; that is because the browser is always open. In an example, with the interface the GUI generally requires just two touches to either open any website or open any application.

1.4. Browser with Expandable Docking Area for Icons

In an example (see e.g. FIG. 2), the interface has expandable multiple panes/docking areas 1 within a browser window 11; here multiple websites and application hot link icons 15, organised by the user into specific categories 4, are shown in each expandable pane 1. Each pane has a user selectable category tab 16, labelled appropriately; selecting the category tab 16 causes the pane 1 to expand, revealing the icons 15 typically arranged in vertical columns of eight. Users can move icons 15 and thus saved websites and Apps between different panes and organise their placement within a pane 1. The icons 15 can be moved by the user by dragging them into different positions in the docking area 1. The function is totally dynamic and the user can rearrange the icons in any fashion he or she wants. Icons can be rearranged within folders and moved between folders. A user can move an icon into another folder simply by pushing it towards that folder. When the icon is over the destination tab it is highlighted. Removing the user's finger saves the icon to the new folder. A user can create a large number of folders, each with up to a large number of icons. The icons 15 can automatically be filled to fit the pages so the user has a convenient way to view them. Icons 15 for websites that a user wishes to save as favourites or bookmarks can be chosen from local pre-loaded generic libraries or searched for as specific icons on the web; either is automatically added to a tabbed pane of the appropriate category of the user's choice.

The user can interact with the expandable panes/docking areas in several ways causing the docking area 1 and category tabs 4 to move out to be in a layer over the App or website or to move back to a hidden position with only an indication area 12 where the user can cause the pane to move. In one example the pane can be expanded as much or little as the user desires.

### Section 2 Overview

There is provided an object orientated combined Desktop graphical user interface (“GUI” or “interface”) that in different examples can be distributed as either a Web Browser or a Desktop interface replacing user operation functionality of the operating system (OS) for a general purpose personal computer and other touch-screen, keyboard, voice or mouse-controlled computing devices. The interface displays (see e.g. FIG. 2) a user's favourite websites and locally mounted Apps as graphical pictograms (icons) 15 saved in library folders of different categories 4 that are accessed via labelled category tabs 16. As a Web browser offers the user an easily accessible and memorable visual choice of favourite websites without the need, as with conventional browsers, to scroll down lists of text based bookmarks or favourites the user interface provides the same functionality for all user content within the system.

As a Desktop interface the user is provided with easy and direct control of locally installed Apps represented by icons 15 (see e.g. FIG. 2) in the same manner as websites. These Apps are displayed within the same user interface 14, in the same way as the websites. The desktop interface could either be an extension and/or replacement to the GUI of an existing OS, such as Android, iOS, or Windows, or could in another example be the entire system. The implementation covers the way the user interacts and the implementation can be made in different ways. The main advantage is that with no differentiation between how to access web browsing and controlling Apps the user will never, or in another example, seldom, need to navigate away from the user interface 14.

### 2.1. Functions

The interface 14 (see e.g. FIG. 2) may provide an environment for the user to navigate the web and/or access applications. It has two combined but distinct functions—firstly as a web browser to access the World Wide Web (Web) and secondly a desktop function to access and control locally mounted Apps. The desktop function replaces the need for the user to interact with another OS on the device. Although eliminating the need for interaction with any other OS, the interface 14 can be applied in different ways. It could either be an environment replacing the GUI of the OS, an environment replacing the entire OS, or simply be installed as a third party application. As a third party application the environment can be used either with only its own saved website links and applications or it can interact with the rest of the OS by allowing access to the locally mounted applications outside the application. Access could also be granted to, for example, bookmarks, other webpage references, and external application stores. In another example the system could have its own application store.

The web browser function could in one example require the host general purpose computer to be connected to the Internet, typically by a wired LAN (Ethernet) connection, or via a wireless WLAN (Wi-Fi) broadband connection, or via a cellular telephone network (3G/4G) or satellite system, or via dial-up fixed line telephony. In another example the system could be used in offline mode and have websites stored within the device for the user to navigate locally cached data. No Internet connection is required for users to access locally installed Apps on the host general purpose computer; however, this does not limit the possibility that some applications might require an internet connection for full, or any, functionality.

### Section 3 Features of GUI

The GUI illustrated by way of example in the Figures illustrates the web browser application, but could, without any visual modifications be used for the desktop applications as well. An important feature of the GUI (see e.g. FIG. 2) is the docking area 1 containing the icons 15 used to navigate to websites or to open applications. Those can be modified by the user if preferred. Initially the system contains a number of categories 4 by default.

An example of the user interface is illustrated in FIG. 2 and includes the following elements for the user to interact with: Settings 2, Address field 3, Browser Area 11, Navigation buttons 5-9, The Snap function 10, Tab Reveal Arrow 12, Categories 4, and Website and Application Docking Area 1. The entire interface is labelled as the interface 14.

In addition to the interactive elements the interface also includes the present time displayed in the top right corner 13, the information & status bar and a progress bar built in to the address field 3. Time can be shown in different formats, including 24 hour and 12 hour AM/PM format. The time can be set via the Settings Menu.

### 3.1. Settings—Tapping on the Logo

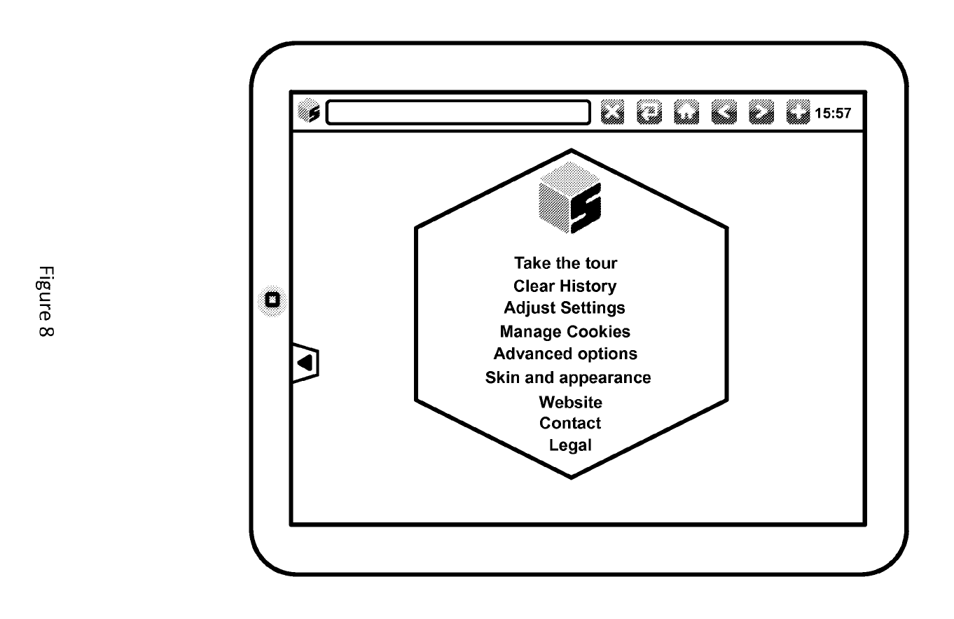

In an example, system settings can be accessed by tapping on an application logo 2 within the user interface (see e.g. FIG. 2). This could in different examples either navigate the web browser to a settings page allowing for user input or open a settings window. The latter is illustrated for example in FIG. 8. Settings could include, but are not limited to; Link to company Help Website, News, Adjust time & Date, Clear all History, Clear Cookies, Change looks and feel (offers the use choice of ‘skins’ for the UI), About (version details, patent & registered design details, authorship and design credits), and Advanced options—(customize buttons, multi-touch gestures, and other features such as task manager and force quit applications).

### 3.2. Information & Status Bar

The information & Status bar can in one example be included in the address bar 3 and includes information about the current state of the application. This information could for example include if the application is performing any calculations currently, or the name of the application, the web page address or similar. In applications that normally utilize a full-screen mode, the information & status bar could be used to show additional information from the application, such as lap times in a racing game or which cell that is active in a spread sheet application and if selected being used to alter the cell content.

### 3.3. History

In similar fashion unlike an ordinary web browser the history of the user's Web Browsing and Apps usage may be saved. An advantage is that no distinct differentiation is made between applications and web pages. This enables the user to navigate seamlessly within the history not taking into consideration in which application or website the previous user interaction, operation, or task was performed.

History can be selected, for example, by clicking on an icon in the top-field. The history of the latest websites browsed and apps used is now listed using icons with text as illustrated in FIG. 9. More entries can be viewed by scrolling, or tapping on the Search Pane and entering a text search. Tapping anywhere on the screen closes the history panel.

The number of websites and/or apps to be shown can be altered by the user by changing the settings. The items in the history to be shown can also be chosen for instance by setting a date and/or time range for when the website or app was visited.

An option to clear the recent history is also provided. The user can set how long a period in the past to clear the history, either by setting a time related period such as a time going back from now or a specific date/time range. The option to remove specific items such as every webpage with a specific domain or navigation path or a specific App from the navigation history is also provided. Thus the items can be removed from the navigation history list by specific user selection.

The history function may be used to store information about previous navigation sessions performed by the user. In the present case this includes, and doesn't differentiate between, previous websites and applications. This enables the interchangeable switching between previous applications and websites. This is utilized in the interface either from a history menu, as illustrated in FIG. 9, or by the navigation buttons (navigation buttons described below and illustrated in e.g. FIGS. 2 and 3 as items 5-9). The user could choose any entry from the history menu, see e.g. FIG. 9, in order to directly navigate to the previous state, for example choosing “News feed” 24 would navigate the interface to the Facebook Application News feed 24. This would automatically add “Facebook Application—News Feed” at the end of the list (not illustrated in FIG. 9). If the user after this were to use the navigation buttons and press backwards 8 the interface would navigate back to “http://www.amazon.co.uk” 26.

In addition to the standard history navigation features, the interface also includes advanced options for the user to navigate between different states and levels. In the example above the user uses the backwards button 8 to navigate one step backwards in the history menu: see e.g. FIG. 9. For different reasons, such as convenience and ease of use, the user might want to navigate between application in the top level 21, 23, and 26 without having to step through every sub-level 22, 24, and 25. In the example where the user is at “http://www.amazon.co.uk” 26 a backwards navigation command would instead of going to “My Profile” 25 mean that the application navigates back to the initial page of the “Facebook Application” 23. The same thing applies to sub level domains as illustrated by “http://www.google.co.uk” 21 and its following image search 22.

It is to be understood that the backwards button 8 could be configured to do either of those two navigation features. In one example the navigation features could be done by different multi-touch gestures, for example, “three-finger-swipe, left or right” would do forward or backwards navigation between each step, e.g. 26 to 25, while “four-finger-swipe, left or right” would do forward or backwards navigation only to top levels, e.g. 26 to 23 or 25 to 23.

### 3.4. Address Field

In one example the address field 3 has the function of a conventional web browser, meaning that a user can type a Uniform Resource Locator (URL) in order to navigate to a website. If the user does not enter a complete URL or a string that is interpreted as a URL for instance because it starts with “www” or has “.com” at the end, the interface instead causes a lookup through any, by the user or by default, specified search engine. In another example the address field includes auto-suggesting features presenting icons 15 to the user depending on the string entered. This is further described below.

### 3.5. Browser Area

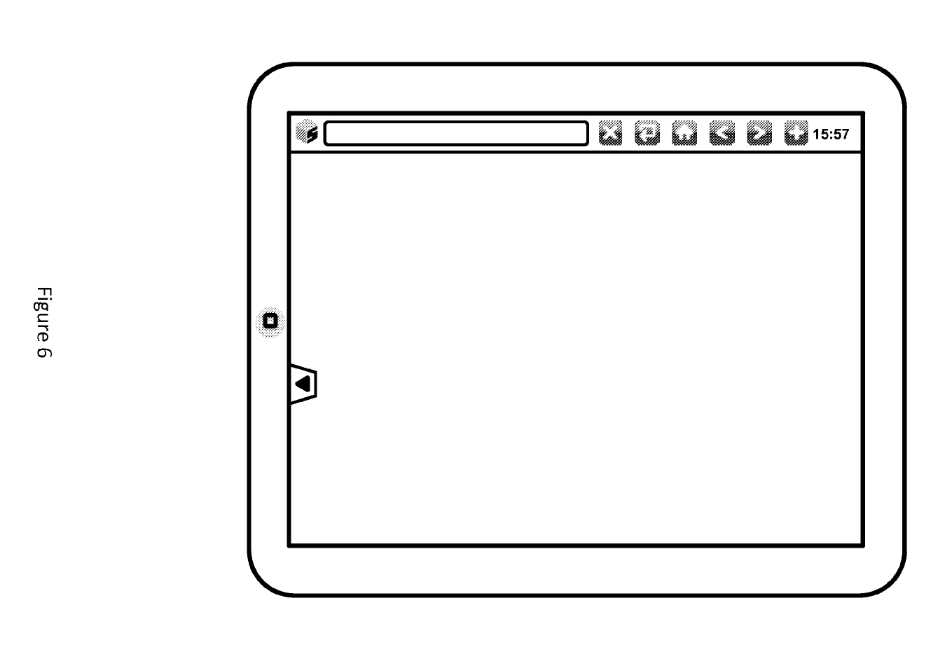

The browser area 11 is the area of the interface where websites and apps are presented. In one example the browser area is of a maximised size, as indicated in FIG. 6 describing the plain interface, when other parts of the interface also use a part of the screen, where the website or app is displayed in a similar fashion as a normal website. In another example (not shown) the browser area is expanded to full-screen mode with the top-pane 55 hiding in a similar fashion as the docking area 1.

### 3.6. Navigation Buttons

The navigation buttons are represented by icons, illustrated e.g. in FIG. 3; the user has the option to trigger different navigation functions by tapping any of the icons. The functions are described below.

Back Navigation icon 8—tapping on this icon repeats the previous web browsing or app usage.
Forward Navigation icon 9—tapping on this icon repeats the next web browsing or app usage.
Refresh Web Page icon 6—tapping on this causes the web page to reload.
Stop Loading Web Page icon 5—tapping on this halts the progress of a web page loading.
Home icon 7—tapping on this navigates the browser area to the user's start page.

### 3.7. The Icon Creation Function

The icon creation function 10 may be initiated by tapping the “+” icon (see e.g. FIGS. 2 and 3). This prompts the user to save a currently browsed website by way of choosing a library icon, a part of the displayed website, a part of a saved photo, or search the Web for a suitable icon. See below for further details.

### 3.8. Tab Reveal Arrow

The Tab reveal arrow's 12 function (see e.g. FIG. 2) may be to hide/show the docking pane 1 and the categories 4. By tapping on the Tab reveal arrow 12, the user hides or shows the docking pane 1 and the category folders 4 depending on the present state of the application. The tab reveal arrow 12 only illustrates one way of performing this action; other possibilities include swiping or dragging from the side, double tapping, tapping with multiple fingers, or any other tapping/clicking sequence or swiping/dragging pattern. The docking pane can be expanded/shown either to a set size where all the icons in the current selected tab are revealed without scrolling or it can be expanded to a distance set by the user either as a presetting or by the swipe/click or drag motion performed by the user.

### 3.9. Categories

The categories 4 may function like folders or tabs where the user can store and sort the icons 15 he/she has created. The user can create new categories 4 and reorder or remove existing categories. The interface includes a number of categories 4 by default.

By default the categories 4 can for example be, each representing one tab 16:
Information
Connect
Lifestyle
Leisure
Services
Money
Apps
Spare Folder

The interface also allows for categories 4 created by other users, for example, “My Favs”, e.g. as illustrated in FIG. 2, and can include user created icons, icons created and shared by celebrities, and icons created and shared by friends, or by special interest groups. This feature is further described below.

### 3.10. Website and Application Docking Area

The website and application docking area 1 is the part of the interface where the icons 15 are displayed for the user (see e.g. FIG. 2). Those are displayed, per category 4, when the user taps the Tab reveal arrow 12. The user can reorder the applications within the docking area 1 and move them between different categories 4. The tabs 16 can be rearranged and the bar extends so that the user can scroll up and down making space for additional tabs 16. In the example shown in FIG. 2, the icons are snapped to a grid auto-arranging them in order. In another example the user can arrange them freely in the docking area 1. The docking area 1 can be expanded to fit more icons 15 through either generating more pages that the user can switch between as described below or by adding more icons 15 and enabling a scroll function.

The docking area 1 contains the icons 15 representing links to pre-loaded, shared, or user-saved websites or Apps. They are arranged in columns: in the illustrated typical case in columns of eight. However, it is to be understood that any arrangement of numbers could be implemented.

### 3.11. Status Field and Other Controls

It is further to be understood that any control in the GUI can be implemented by way of swipes, drags, or any other gestures or controls well known in the art. The implementation is not limited to the interaction methods described above.

In one example, the top-pane 55 includes additional features, which are illustrated for example in FIG. 33, that otherwise would be handled by the OS. This could include a Wireless (Wi-H) Connection strength Indicator 56 and/or a battery indicator 58.

Tapping on the indicators, in this example the Wi-Fi 56, takes the user to a Wi-Fi settings page where e.g. different networks can be selected, security details entered and priorities set. The battery icon would indicate whether the computer is running on battery 58 or mains power 57. The top-pane 55 could also include other features such as, date, time, geographical region, language, and preferred skin. In an example, all of the mentioned features are configurable by simply tapping on them in the top-pane 55.

### 3.12. Using the Interface

The interface 14 (see e.g. 2) comprises possibilities for an object-oriented Desktop and/or Browser where a user's favourite websites and Apps are arranged in expandable docking areas 1 of customisable categories 4 accessed through category tabs 16. The category tabs 16 are by default auto-hidden and indicated by the tab reveal arrow 12. The expandable docking areas are animated into the viewing area from the left or right side of interface by a finger tap or click with a mouse on the tab reveal arrow 12.

Selecting a category tab 16 by a tap or click reveals icons in an expandable docking area 1 arranged in columns—in this example “Information”.

Within each docking area 1 icons 15 represent links to pre-loaded or user-saved websites and/or Apps arranged in columns. A favourite website is browsed or an application is launched by tapping or clicking on its linked icon 15.

Tapping or clicking on the category tab 16 again or in the viewing area auto hides the docking area 1 and category tabs 16 allowing the website or App to be viewed in full screen mode.

It is to be understood that any number of icons shown in the illustrations are only exemplary amounts and a wide range of numbers of icons can be implemented. By tapping or clicking on the tabs, the docking area 1 and category tabs 16 auto-hides, allowing the user viewing in full size of the App or web browser.

The interface allows for user intervention, including but not limited to, swipes, clicks, drags, taps, keyboard input, and voice recognition. Those features are interchangeable and it is to be understood that a tap can be replaced by a click, a swipe replaced by a drag and that combinations can be implemented in order to open, for example, open tabs, navigate, rotate figures, or similar.

### Section 4 Features

### 4.1. Renaming a Tab

A user can rename any of the category tabs 16 by double tapping on a chosen category tab 16; it is to be understood that this can be done in any other user interactive way as well, such as by tapping and holding, tapping and swiping, or a gesture pattern.

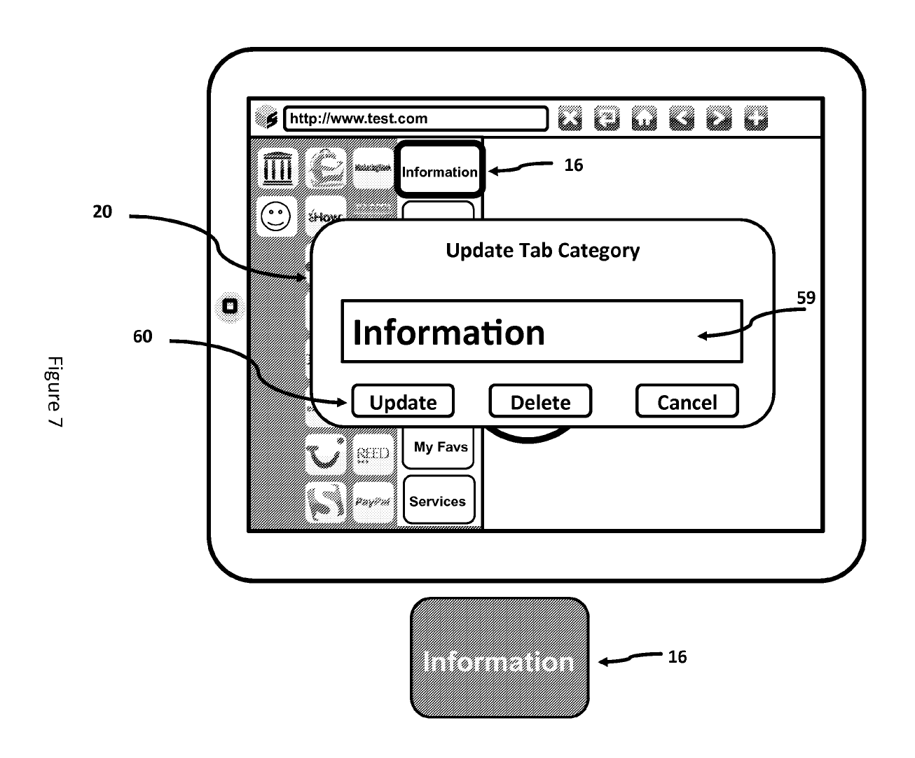

In the example shown in FIG. 7 the user renames a tab category 16 currently named “Information”. The user renames the tab by double clicking on the category tab 16 and is then prompted with an “Update Tab Category” box 20. The user changes the text within the name field 59 and presses the “Update” 60 button in order to confirm the action.

### 4.2. Saving a Favourite Website

The interface 14 can be preloaded with a wide selection of the most popular websites in each of the category 4 docking areas 1. In addition to this the interface allows the user to save websites of their own choosing as they browse them and assign icons 15 to them for ease of use.

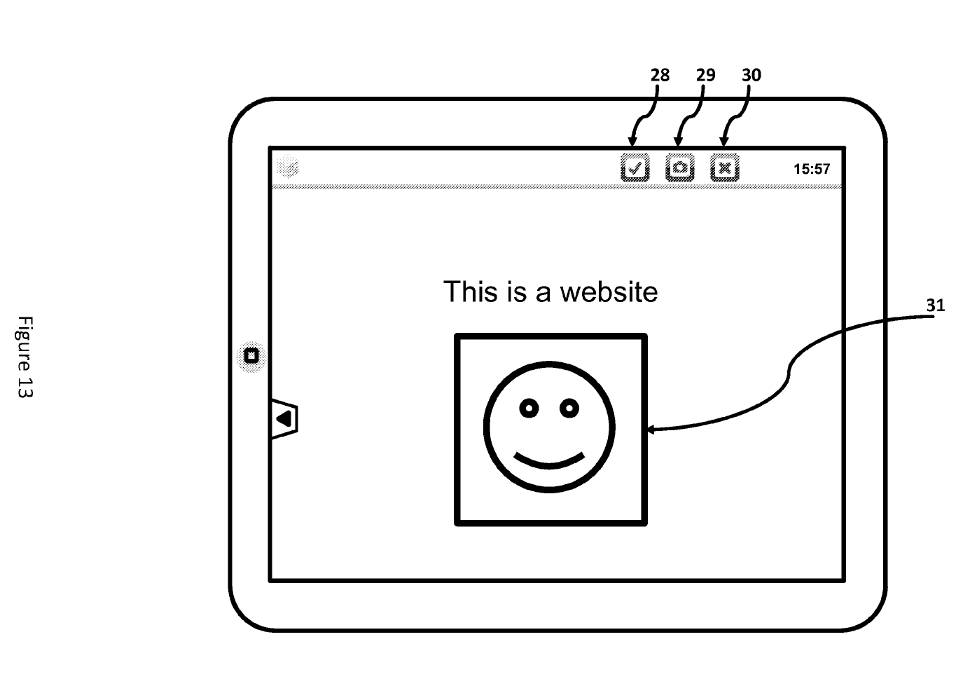

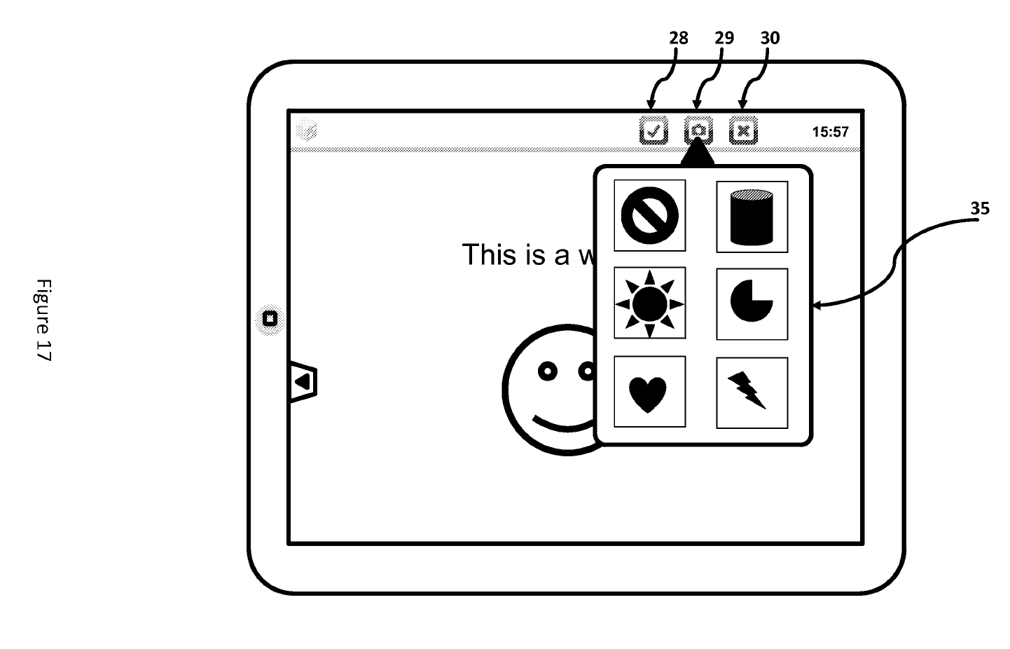

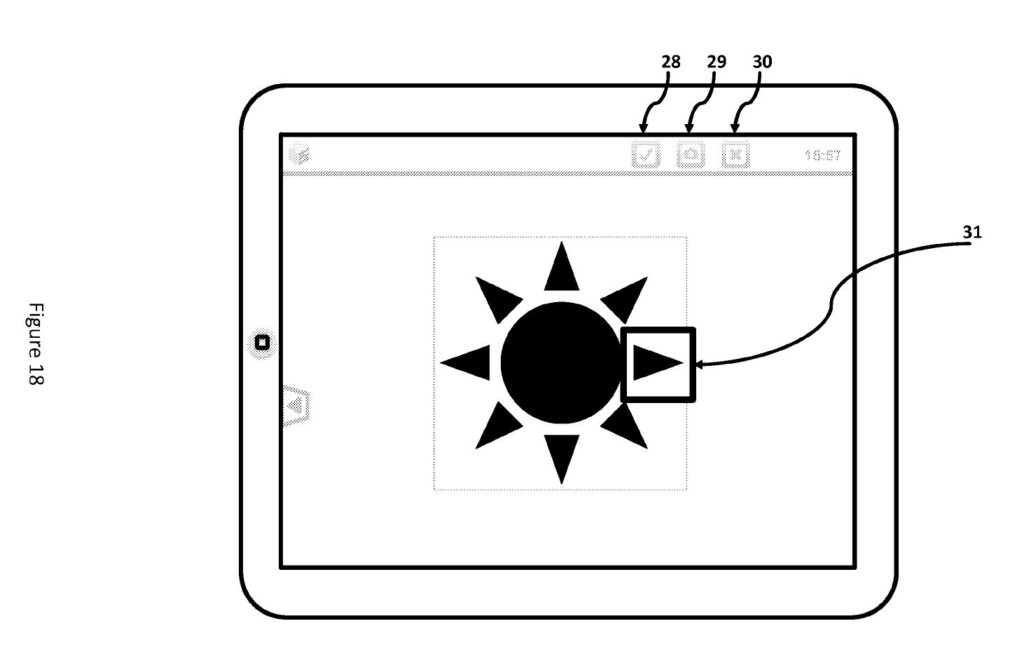

When saving a webpage the user may be required to associate an image with the webpage in order to generate an icon 15 to be stored in the docking area 1. The user has multiple options for doing this, including selecting a part of the website as the image, see e.g. FIG. 13, selecting an existing photo (or a part of it) as shown in FIG. 17 and FIG. 18, selecting from an existing library of icons (same procedure as FIG. 17), taking a picture with the device's inbuilt camera or searching the web for a suitable picture for the icon.

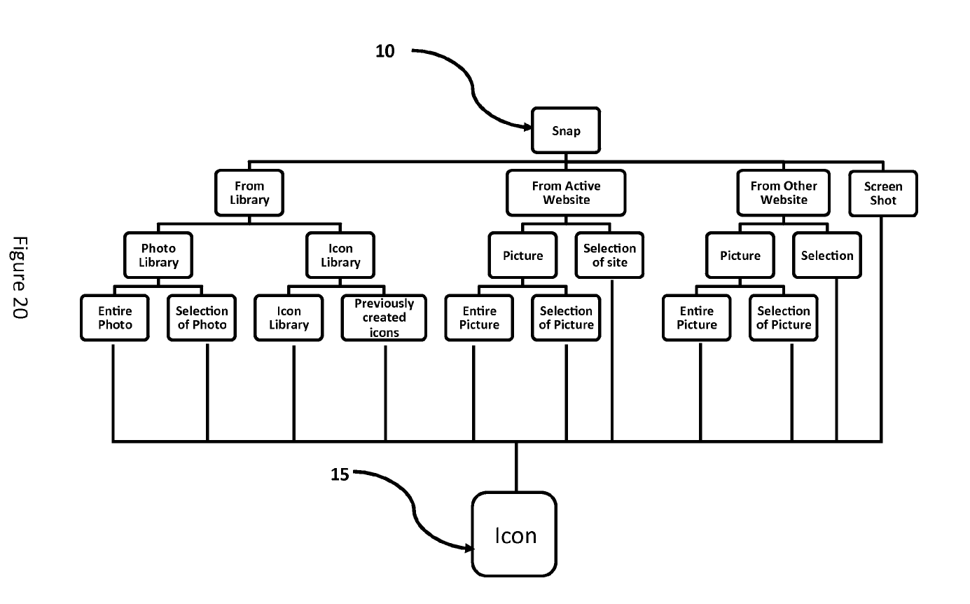

Examples of the selection processes and the different options are described in FIG. 20. In any of the mentioned selection processes for icon photos the user can be prompted, or can manually select, the option to rotate the image.

4.2.1. Saving a Website with a Web Icon

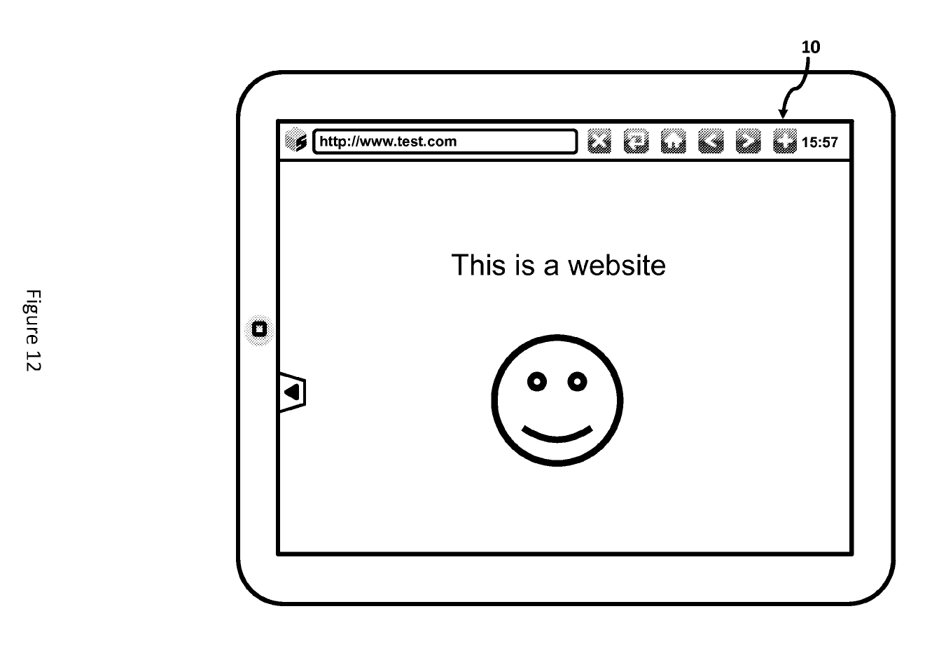

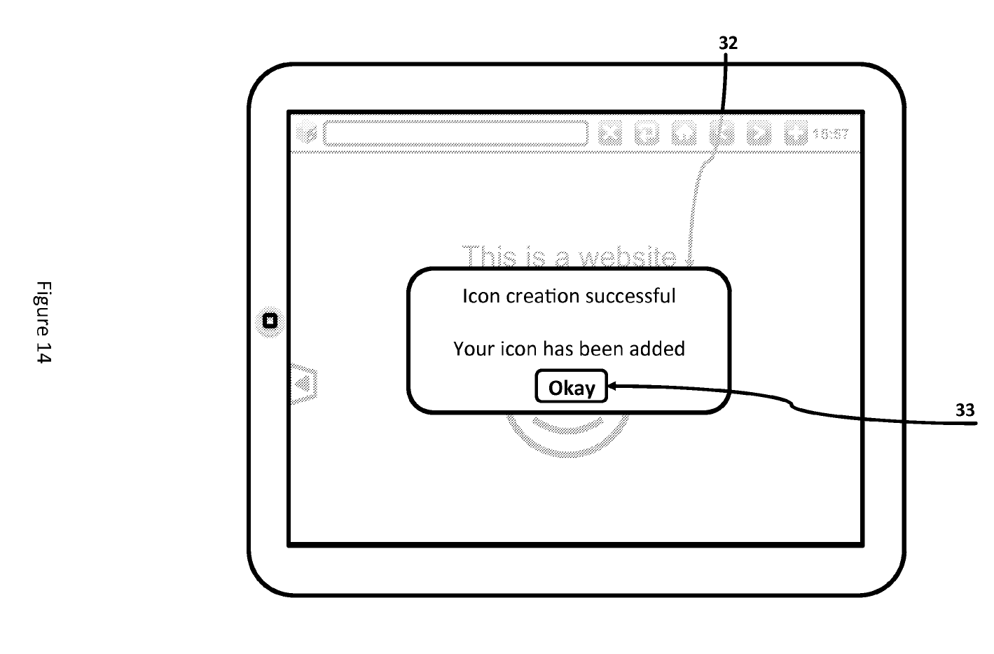

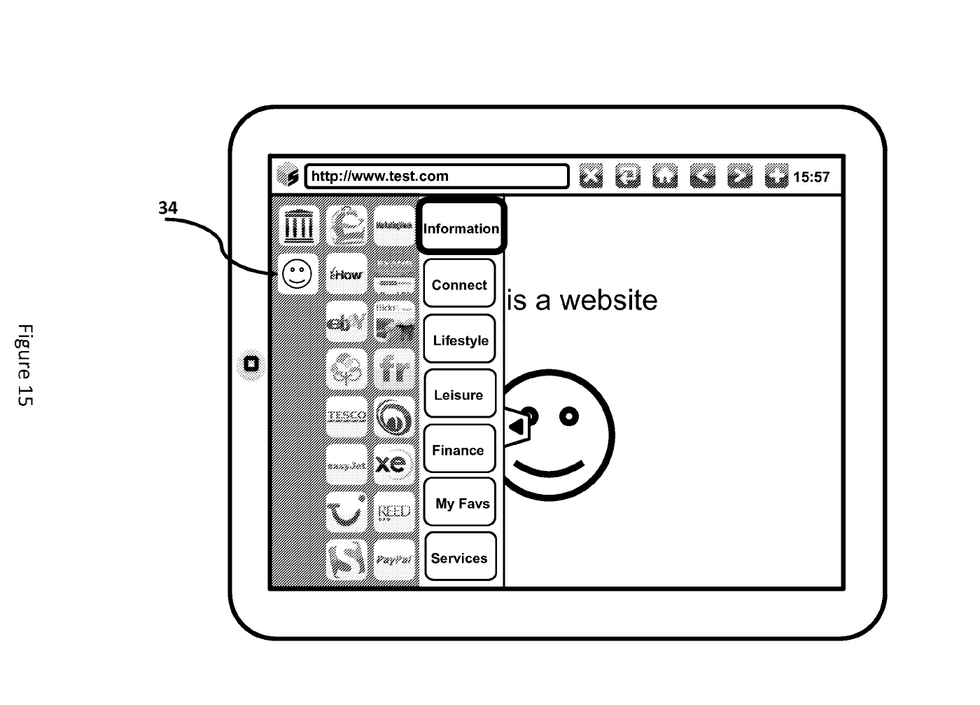

In FIGS. 12, 13, 14 and 15 the process of saving a website and creating an icon 15 from a part of the website is illustrated by way of example. The user taps on the “+” 10 icon when a website that he or she wants to save is active. The user is prompted with a resizable and movable frame 31, illustrated in FIG. 13, which indicates the area of the screen that will be saved as an icon 15 when the webpage is saved. After the user has selected the desired area and pressed the tick icon 28 the user is prompted 32 with the information illustrated in FIG. 14. After the user has pressed the “Okay” button 33, the icon 34 is created and is visible in the docking area 1, as illustrated in FIG. 15.

In another example, the user can instead choose to browse the web for a suitable icon image in a similar fashion as selecting one from the saved website.

4.2.2. Saving a Website with a Picture as the Icon

The user also has the possibility to choose a motif for the icon from the computer's photo album, see FIG. 17 icon library (same implementation as FIG. 17), or taking a fresh photo with the device's inbuilt camera. The process is similar for those three examples and the process of using a photo/picture from the device's photo library is illustrated in FIGS. 17, 18, and 19.

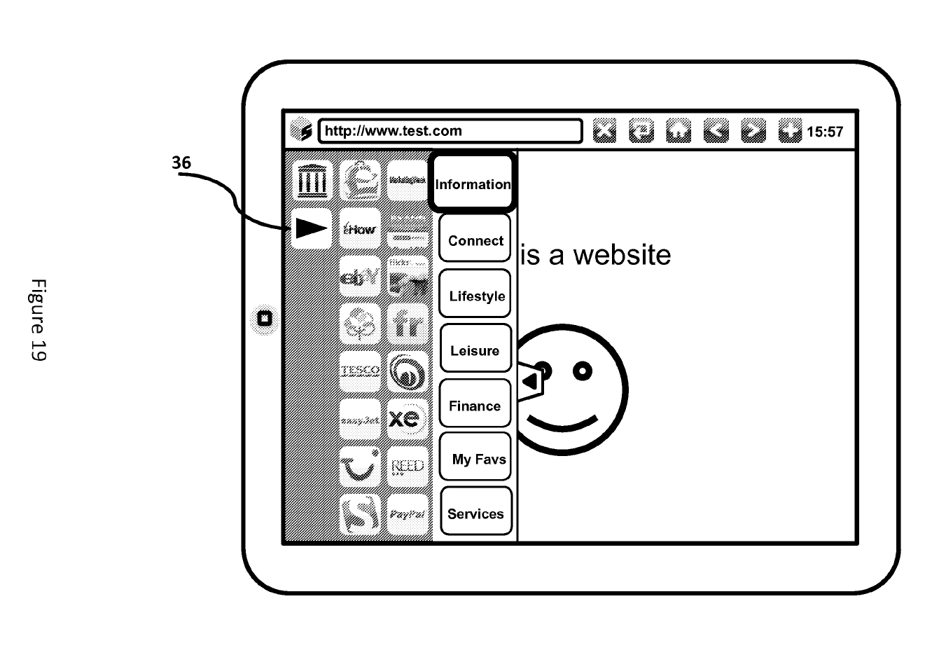

The user starts by tapping on the “+” button 10 (see e.g. FIG. 12) and then the “photo” button 29 (see e.g. FIG. 13); the user also has the option to abort 30 or accept the first or marked photo 28, in order to bring up the photo selection menu 35 from which the user by tapping can select a photo or browse for additional photos not shown in the menu. It is to be understood that the menu illustrated in FIG. 17 is only an example and a wide range of numbers of photos or icons can be presented either in the existing menu box or with the option to scroll or browse for more. After selecting the photo, the user is prompted with a resizable and movable frame 31 (see e.g. FIG. 18) and can select which part of the photo to use as the icon. Finally the icon 36 is created, as illustrated in FIG. 19.

4.2.3. Saving a Website with an Icon from the Icon Library

The icon library is another option for the user; the icons are in this example organized in a similar way to FIG. 17 but instead of photos the user can choose from icons that already have the optimal size. The icons could in one example be categorized in a similar way as the tabs, for example, the user decides to save a suitable Library Icon from the Connect category 4 by tapping on a selected icon. Having chosen to save it in the Lifestyle category tab, they tap on “YES”. This opens the Lifestyle category tab and adds the new icon to the docking area. The icon library also includes a copy of every icon 15 previously created by the user in order for the user to be able to associate a specific image with a specific sort of content.

4.2.4. Saving a Website with a Screen Shot

The user can select to save an icon with a screen shot to remember a website by. In one example, the system auto-fits the screen shot to the icon, in another the system crops the screen shot in order to get the correct ratio.

4.2.5. Saving a Website with a Suggested Image for the Icon

Instead of choosing a selection from a website, the user can choose to select an image displayed on a website by holding, double tapping, or by any other selection method, and after that choose if to include the entire picture or to choose a selection of the picture to be used as an icon.

### 4.3. Adding User Information to a Saved Website or an Application

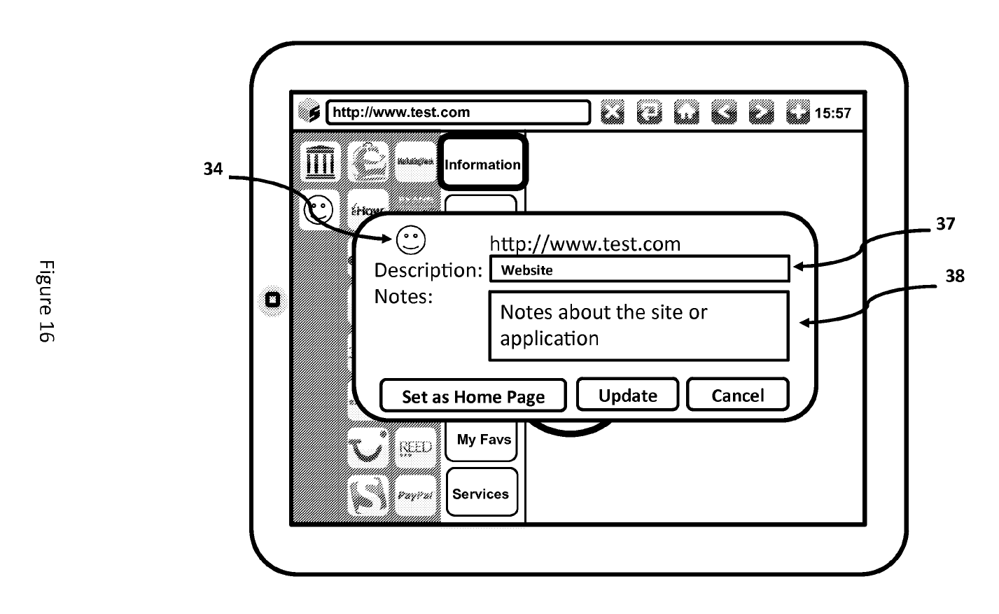

The user has the possibility to edit any created icon by for example double tapping on the icon. It is to be understood that the double tapping can be replaced with any other tapping pattern, gesture, or other interaction well known in the art. Such an interaction would bring up an input box e.g. illustrated in FIG. 16. The user has the options to enter a description 37, some notes 38, set as a home page, and/or change the icon by tapping on the illustration of it 34. By double tapping on an icon, a user can add their own notes. In an example, a user can add comments in either of two text boxes by tapping on them.

### 4.4. Deleting a Saved Website or Application

The user can delete websites or applications from the docking area 1 by dragging the item (icon 15) away and dropping it in any other area of the interface 14, or by pushing the icon into the viewing area. This can also be accomplished in similar ways, like double tap, or tap and hold. In one example the user could tap and hold on the icon revealing a removal indicator on the icon that could be tapped in order to delete the icon. Before the application or website link is deleted the user is prompted to confirm the action. In one example this procedure will delete Apps from the device, in another they would only be removed from the docking area 1 and thereby it would be possible to restore them with an application menu or similar.

The interface also presents the user with two additional options instead of deleting the icon permanently. Those are ‘move to archive’ and ‘move to trash’. The ‘move to trash’ function works like a conventional computer recycle bin meaning that the user later can restore the content from the trash or empty the trash to permanently delete all icons within. The recycle bin would in one example be represented by a separate category tab 16 called “Trash” or “Recycle Bin”. The other alternative, ‘move to archive’, removes the icon from the docking area 1 and instead places it in an archive, accessible either offline or online. The archive is in one example presented as a website in the browsing area or as a menu in the interface.

### 4.5. Auto-Suggestion

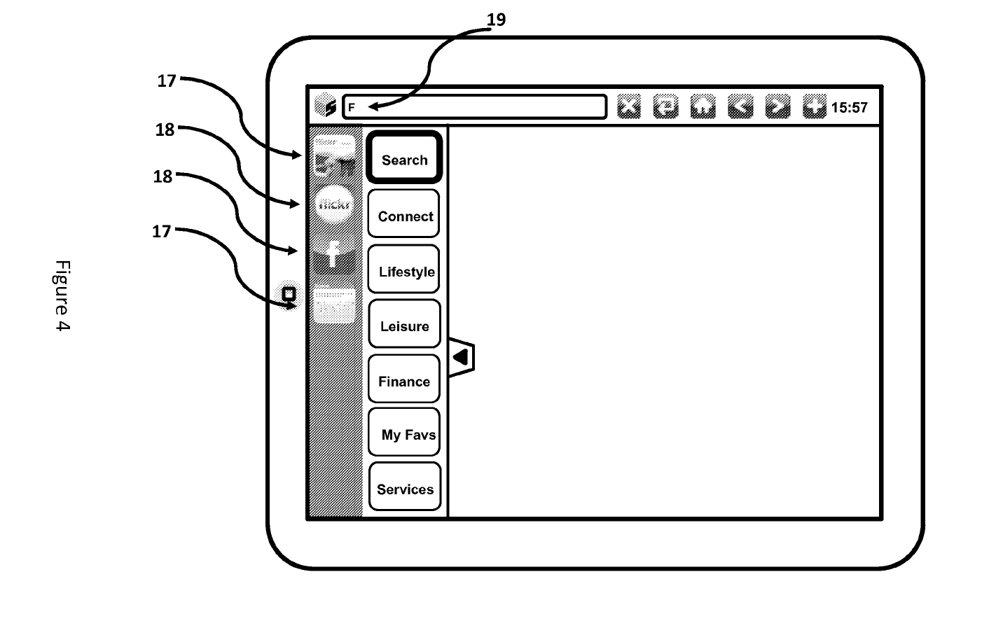

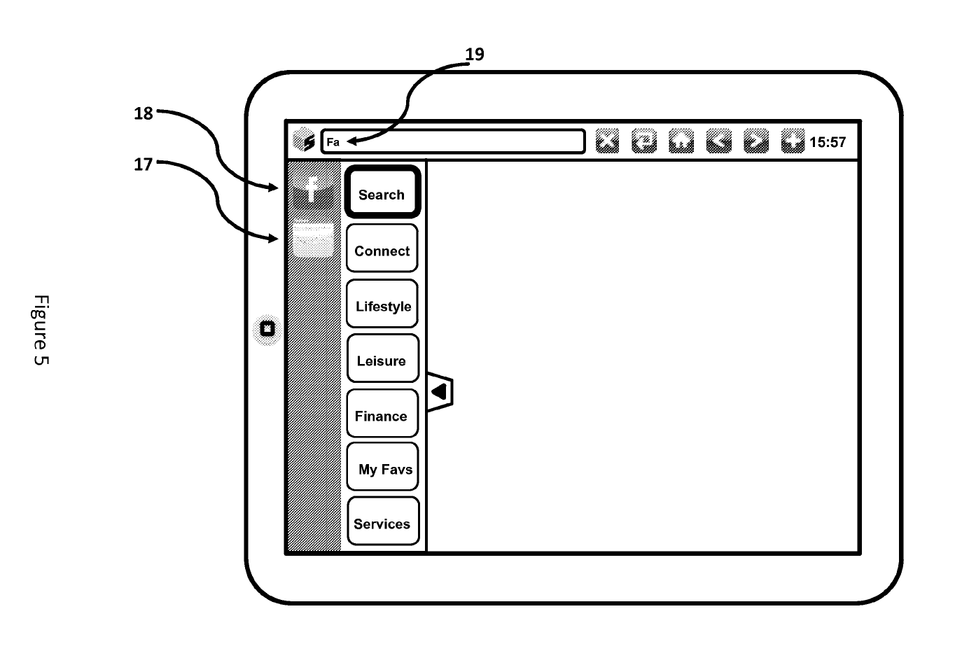

The auto-suggestion feature (see e.g. FIGS. 4 and 5) is a feature implemented in the address field 3 described above. In one example the address field 3 has the function of a conventional web browser, meaning that a user can type in an URL in order to navigate to a website. If the user doesn't enter a complete URL the interface instead causes a look up through any specified search engine, specified by the user or by default. In another example the address field includes auto-suggest features presenting icons 15 to the user depending on the string entered in the address field 3. If the user starts to enter a string, the docking area 1 is automatically revealed and populated with stored websites and applications icons 15 matching the typed string 19 in real-time. For example, if the user starts to enter “F” the system displays the icons 15 for matching results, in our example; “http://www.flickr.com” 17, “http://www.facebook.com” 17, the “Flickr App” 18, and the “Facebook App” 18. The user can either continue to type the URL or choose to navigate to one of the icons presented by tapping on it. The applications 18 and the websites 17 are displayed together and the system does not differentiate between them. The function is illustrated in FIG. 4 (describing the search after entering a single letter) and FIG. 5 (describing the search after entering a second letter).

The auto-suggestion function searches the name of the application or webpage, the URL, the description 37 and the user notes 38 in order to suggest the best result for the user. In another example the application presents website names instead of icons.

### 4.6. Private Browsing

The private browsing feature can be activated by the user from the interface 14. The function prevents tracking of history on the local device by preventing the interface 14 or underlying process from saving browsing, storing history, cookies, and/or other session data. The function can in one example disable add-ins, specific add-ins defined by the user or the system, or disables all extra features of the web browser.

In addition to the private browsing the present implementation also applies private browsing for applications. For example, if a user downloads an application or stores an icon 15 in private browsing mode, the system will automatically remove those upon termination of the browser session. The user will be prompted with the information that all applications and/or websites stored during the private browsing session will be removed and allows the option to confirm.

The private browsing function also disables navigation history from within the applications to be stored, in for example the history menu illustrated in FIG. 9.

The present implementation also provides for an option to select that specific websites or domains always should be browsed in private mode. The user can populate and edit a list of websites or domain names or domain paths that if navigated to always should be navigated in private mode and no session information for that site is to be stored. The option to populate the list with Apps is also provided in an example.

The option is also provided to set up icons stored in on one of the category tabs 16 always should be navigated to or used in private mode.

In the settings for private mode the user can also set that one of the tabs only will be revealed after that the navigation is set to be in private mode. The option is also provided that starting private mode or revealing the “private mode tab” is only enabled if the user has entered the correct password.

### 4.7. Offline Functions

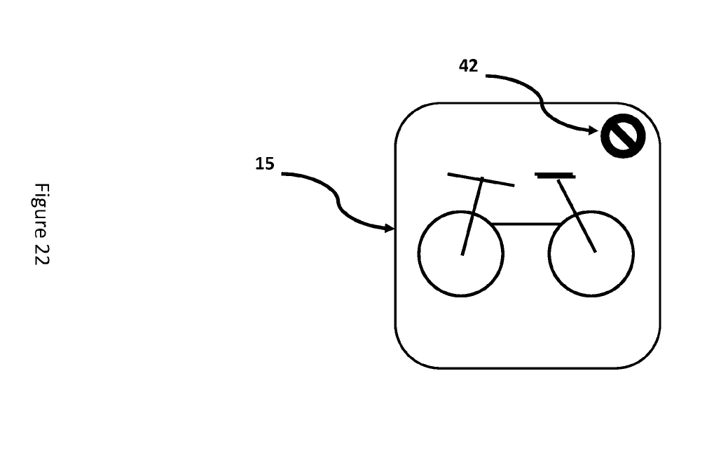

The interface allows for the user to view web content in offline mode. This function is especially useful while travelling, while abroad, or while in areas with limited network connectivity. The interface indicates on both website and application icons 15 if the content is available offline with a symbol 42 in the top right corner of the icon 15. This is illustrated for example in FIG. 22. It should be understood that the indication could be “available offline” or “not available offline” depending on the implementation and purpose of the device.

### 4.8. Viewing Multiple Pages of Saved Icons

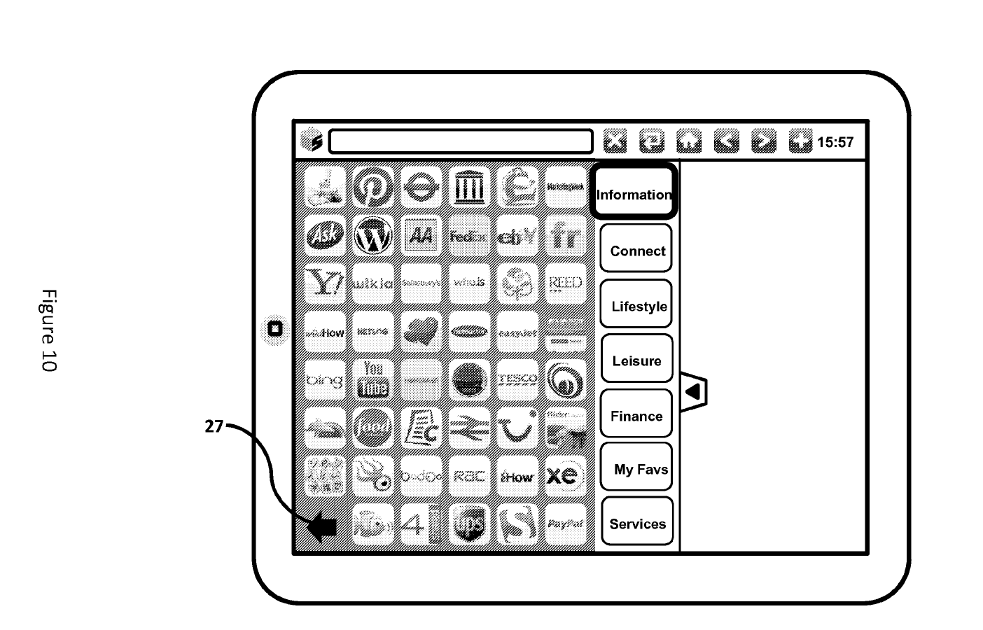

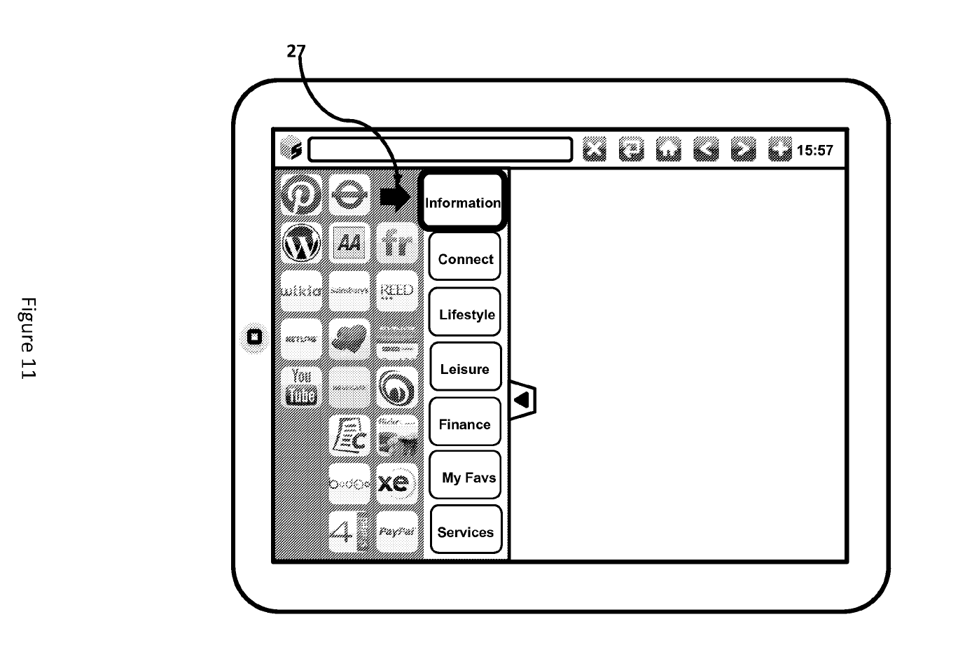

Depending on the screen size of the device the number of icons 15 displayable at one time might be limited. The limitation is based on the convenience of the user in order to allow a reasonable amount of information to be displayed in relation to the screen size. It should be understood that a wide range of numbers of icons might be applicable per page in the docking area 1. When the maximum number of icons 15 is exceeded the last icon is replaced with, in one example, an arrow 27 indicating that there is a second “page” with icons. This is illustrated in e.g. FIG. 10 (first page) and e.g. FIG. 11 (second page, also illustrating every following page). In another example the last icon can be replaced with an empty box or any other indication that there is more information available.

The second page of saved icons, see e.g. FIG. 11, appears with a navigation arrow, empty box, or any other item indicating how to return to the first page of icons. By this method the interface can save an unlimited number of icons 15. In cases where there are multiple pages of icons, navigation arrows in both directions indicate further pages available.

In another example the docking area 1 contains a scroll function to allow the user to scroll the icons, either horizontal or vertical, in a similar manner as to the categories 4.

### 4.9. Icon Size

The size of the icons 15 can be adjusted as a user preference allowing different amount of icons to be shown in each docking area 1 page.

### 4.10. Active Icons

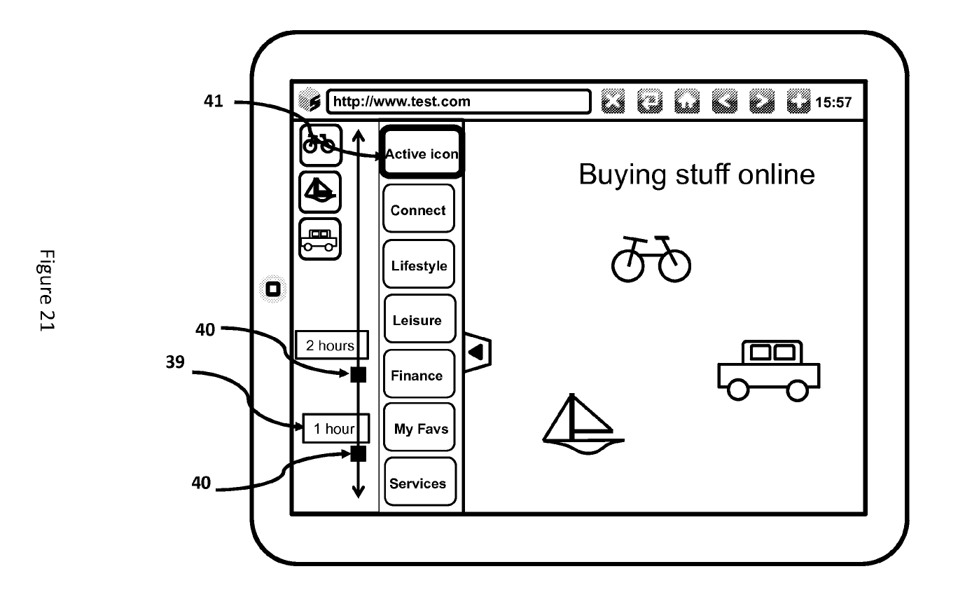

The interface 14 may include a function for ‘disposable’ icons 15 which is a complementary function to conventional tabbed web browsing. The function is illustrated e.g. in FIG. 21 and allows the user to temporarily save icons while browsing the internet. For example, if the user is looking at a “buy and sell site” and is looking at different objects, instead of leaving many session tabs 49 and/or 50 open the user can store icons 15 in the “Active Icon” 41 category tab and view thumbnail icons 15 recalling which object is which. The difference between the “Active Icon” 41 category and the conventional categories 4, e.g. illustrated in FIG. 2, is that the “Active Icon” 41 category tab contains a timeline 40 that allows the user to adjust for how long, or between which intervals, to display icons. By sliding the control on the timeline 40 up and down, the time interval, illustrated by 39, changes. While sliding the icons, the “Active Icon” 41 category is updated in real time to display the ones saved during the time interval. The time interval indicates the time passed since the icon 15 was created. The user can choose the maximum age of an icon 15 in the “Active icon” category tab 41 by entering a maximum value as a separate setting.

In one example the timeline 40 for the current day is more precise allowing the user to choose exactly per minute, hour, or similar, while those for passed days have less accurate settings, such as, AM or PM, or only by days. This function would be for the convenience of the user.

### Section 5 Sharing

The interface enables the user to share or access shared contents from other users in multiple ways. The icons 15 (links to websites or apps) can be shared in different sets, either as icon sets (category tabs 16 are the folders containing icons and each category tab 16 includes a set of icons), as individual icons, or as complete sets (including multiple tabs).

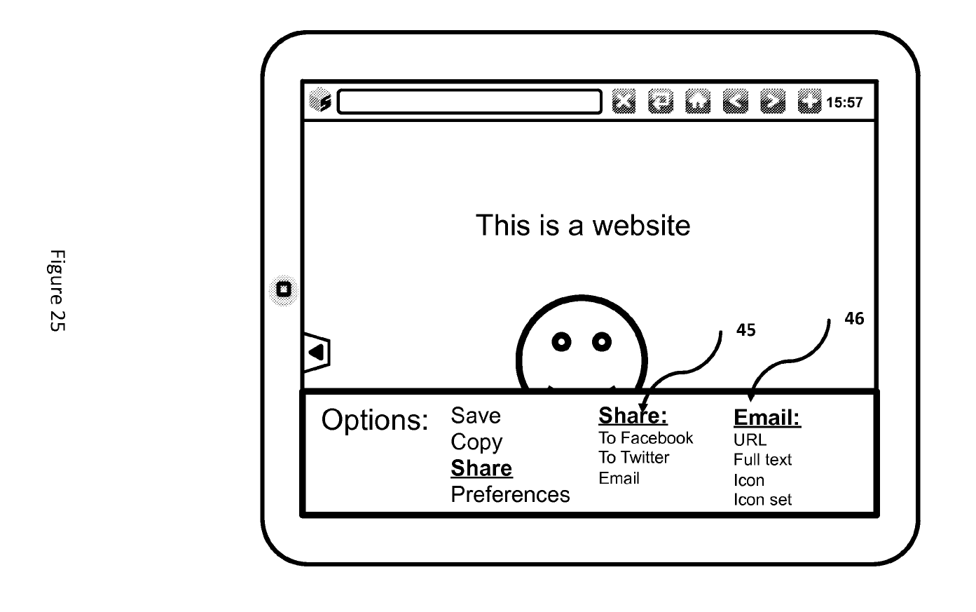

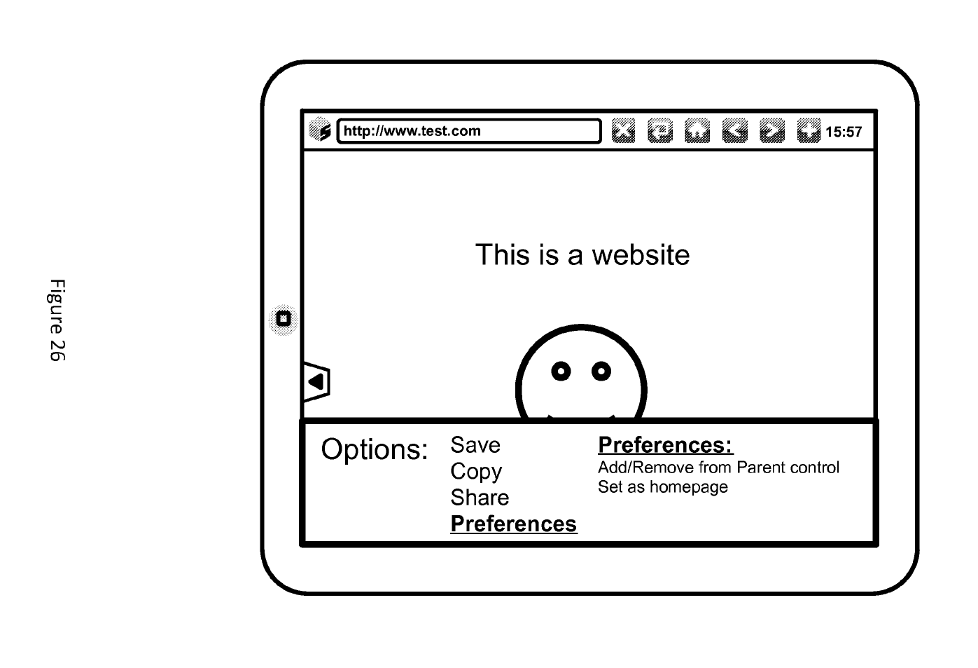

The sharing function in the interface allows the user to share, distribute, and/or subscribe to icons, icon sets, or tabs. The sharing can be done in multiple ways, including but not limited to, emailing links 46, posting through an interface forum 45, marketplace, or website, through social media, such as Facebook or Twitter, sharing links on blogs, subscriptions, and instant messaging (“IM”). One example of how this is conducted in the interface 14 is illustrated in FIG. 25. The user can either share content as it is at the time or accept subscriptions where subscribers or members are sent real-time updates as soon as any of the shared material is changed. This would enable famous, or noted, individuals to share their icon sets for fans to keep up to date with what they are browsing and what applications they use. In addition to sharing icons and icon sets the user can also choose to share their own icon library including all the thumbnails for the icons he or she has created.

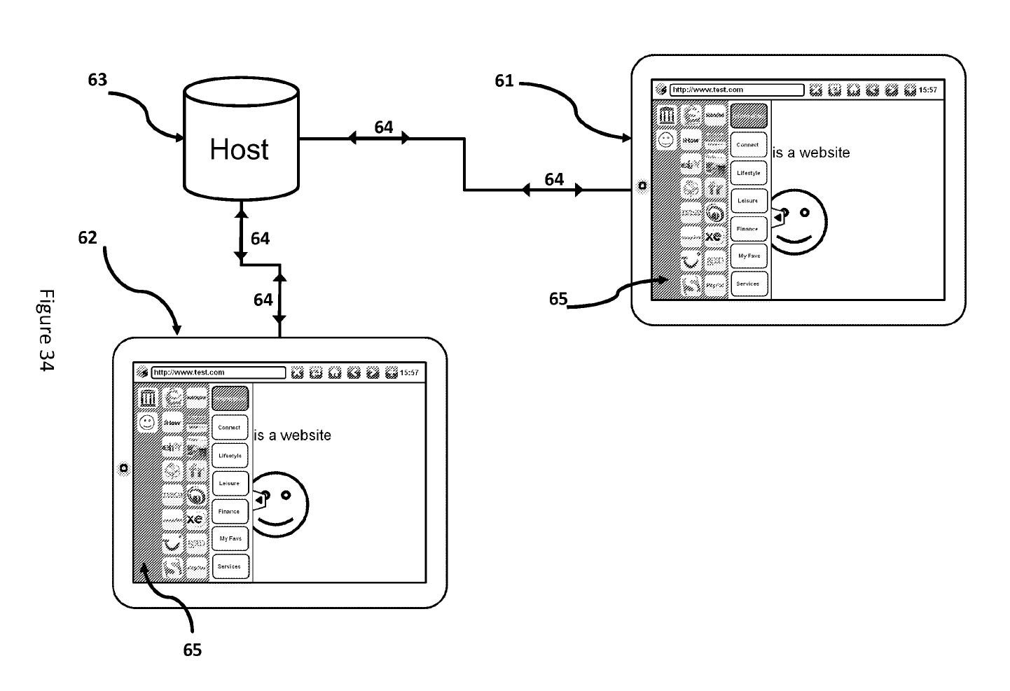

The interface 14 allows, as described, the user to share content. An example of an illustration of this is presented in FIG. 34. Depending on the settings chosen by the user the content can be shared in different ways, including paid-for and free plain sharing, subscriptions, membership and collaborative docking areas 65. The difference between different sharing methods is in how the content is updated as well as how the content is stored. For example, if the user chose to plain share a content tab with icons, he or she, can select who to send the information to. The content is shared from, for example, the user's device 62 through a host server, or servers, 63 to a second user's device 61. The shared category tab 65 is now displayed on both devices. The user of the first device 62 can update the list while the second user's device 61 will only display the latest version. In this example the information can be stored either in the device where it was created 62 or at the host 63, or a combination, for updates to all users in real-time.

As another alternative the user can choose to let other users subscribe to the paid-for or free shared content, in this case the user of the device where the content is created. In this example 62, a user can create and upload the information to the host 63. Anyone thereafter can subscribe to the content and thereby get a mirrored version to their device, in this example 61. The user of the first device 62 can alter the content on the first device 62 and at any time upload a new version to the host 63 that will then be distributed to the subscribers 61.

The user can also choose to have paid-for or free collaborative content, in which case the information is always stored with the host 63. The functionality of collaborative content is that two or more users share content through data links 64 with the host 63 that all users can alter as a community. This can for example be used as a collaborative content tab 65 within an organisation. Any user can drop an icon 15 in the docking area 1 of a collaboratively shared content tab 65 and any other user with access to it can instantly access that icon 15 on their own device.

It should be understood that content includes icons, icon sets, and all other user generated content data within the interface.

In one example a famous, noted or public individual shares as paid-for, free or for a charity donation their own icon set. For example, “What is Paris Hilton snapping this week?” or “What is the prime minister reading this week?” In another example the user sends a web link by tapping on an icon that offers the user the option of sharing the URL either via an email client or via Skype (or another VOIP or IM app) to a recipient. In a third example the user distributes a web link by tapping on an icon that offers the user the option to post the URL to social media, blogs, mail-list or any other sharing possibility. Within any of the above mentioned examples the interface supports up-to-date icon sets changing in real time.

### Section 6 Advertisements

The interface 14 allows for multiple types of advertisements to be shown to the end user. This includes, as examples, a banner in the top, bottom, or side of the screen, a featured category tab with icons for sponsored up-to-date links, and any other form of advertisement shown in the context of the interface 14. In one example, the featured category tab is the tab that is displayed upon starting the interface 14, and/or also the featured advertiser's home page. In another example the featured category tab contains tailored advertisements based on user data, icons saved, and other information gathered within the interface 14.

### Section 7 Additional Features

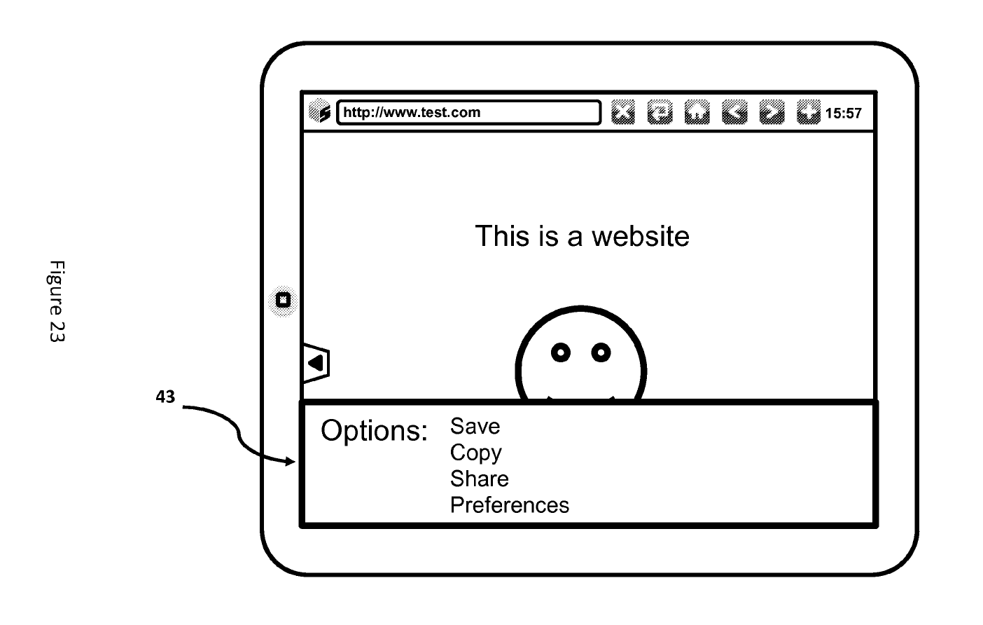

Some of the interface's features can be accessed through an additional menu 43 illustrated for example in FIG. 23. This menu can be reached by tapping and holding a website being browsed. It should be understood that this menu for example could be reached by swiping from the bottom of the screen, pressing a dedicated button, double tapping, or by any other user interaction.

### 7.1. Save & Copy Images in Websites

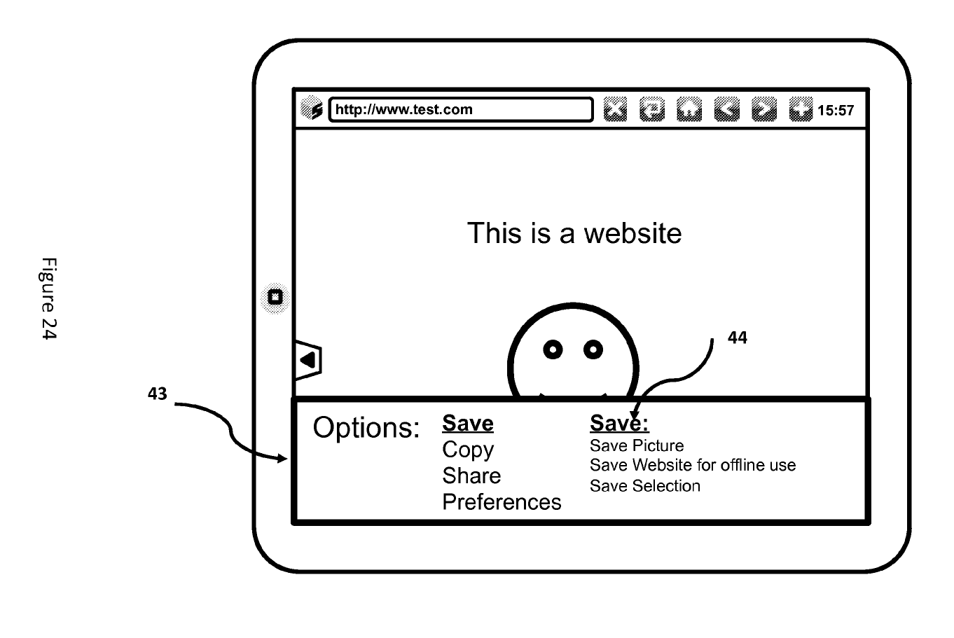

The interface allows for the user to copy or save content displayed in the browser area 11 and store the content on the local device. Content includes selections of the webpage, both as text and an image, full text, images, and the entire webpage. This is illustrated e.g. in FIG. 24 describing an example of the additional menu 43 and the sub menu “Save” 44.

### 7.2. In-App Purchases

The interface may be created for in-App purchases and the options for sale to include additional features such as: icon sets, choice of preconfigured website and icon sets, different languages, territories, content specific for professional or special interests, celebrity choices, and/or Viral Tabs (share sets of websites with other users).

### 7.3. False Desktop ID

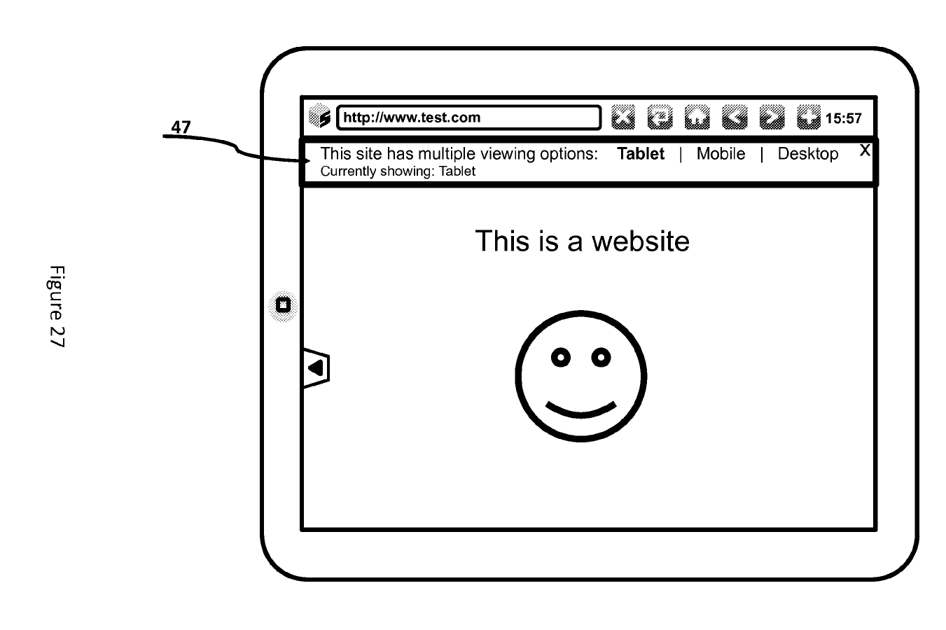

Enabling, for example, a tablet to falsely advertise itself to a host server as a desktop computer avoiding, for example, website redirection designed for mobile users. This function is used to view websites either as tablet, mobile device, or desktop computer. The function includes, where there are multiple options available for a specific site, the interface asking the user in which mode 47, tablet, mobile, or desktop, the webpage shall be displayed. The function is illustrated e.g. in FIG. 27.

### 7.4. Session Tabs

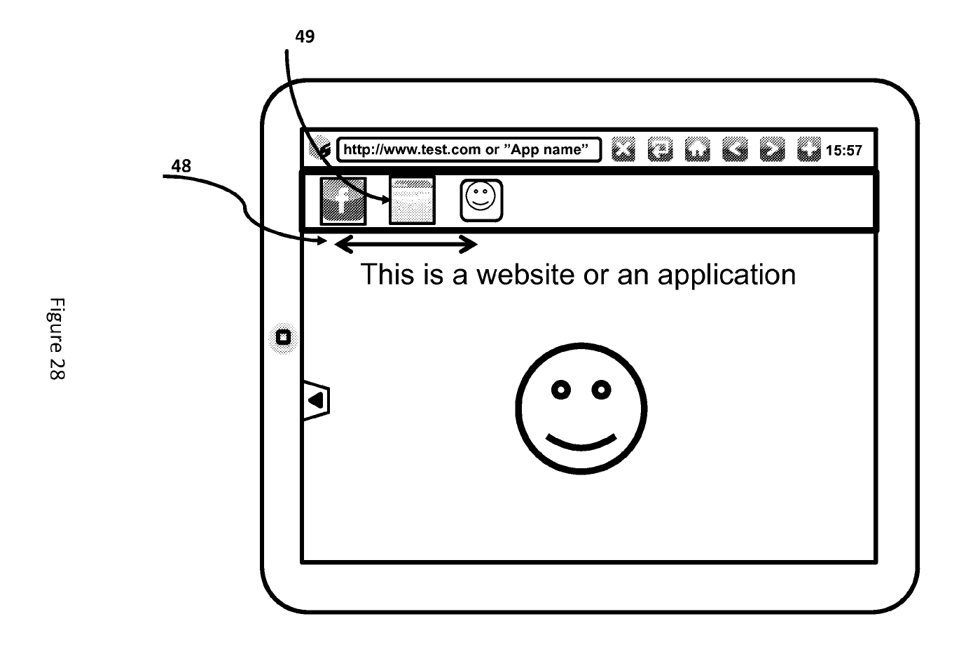

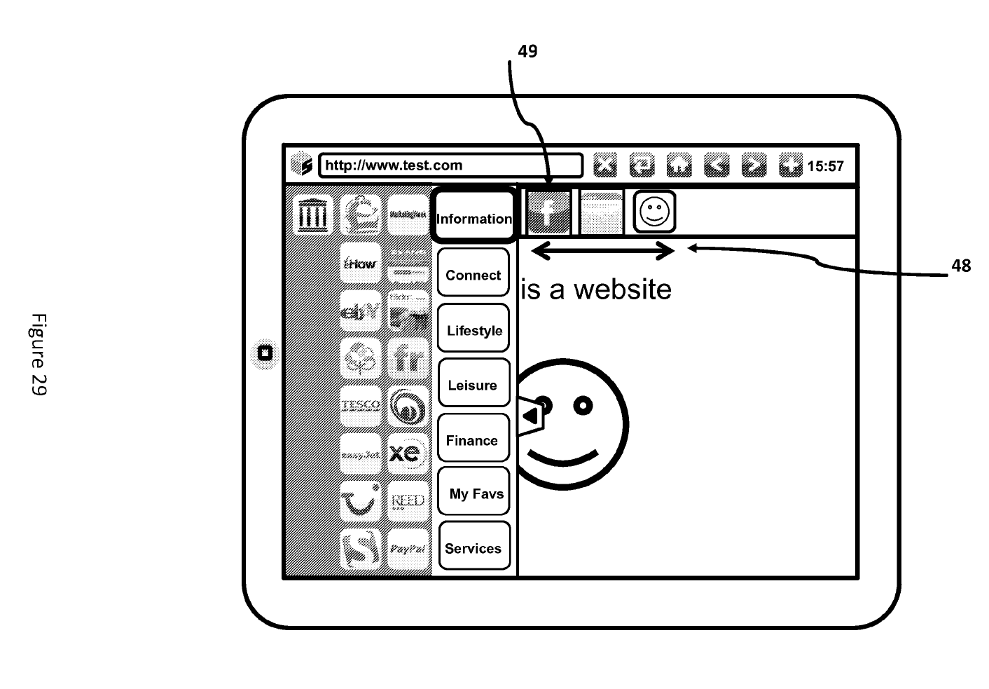

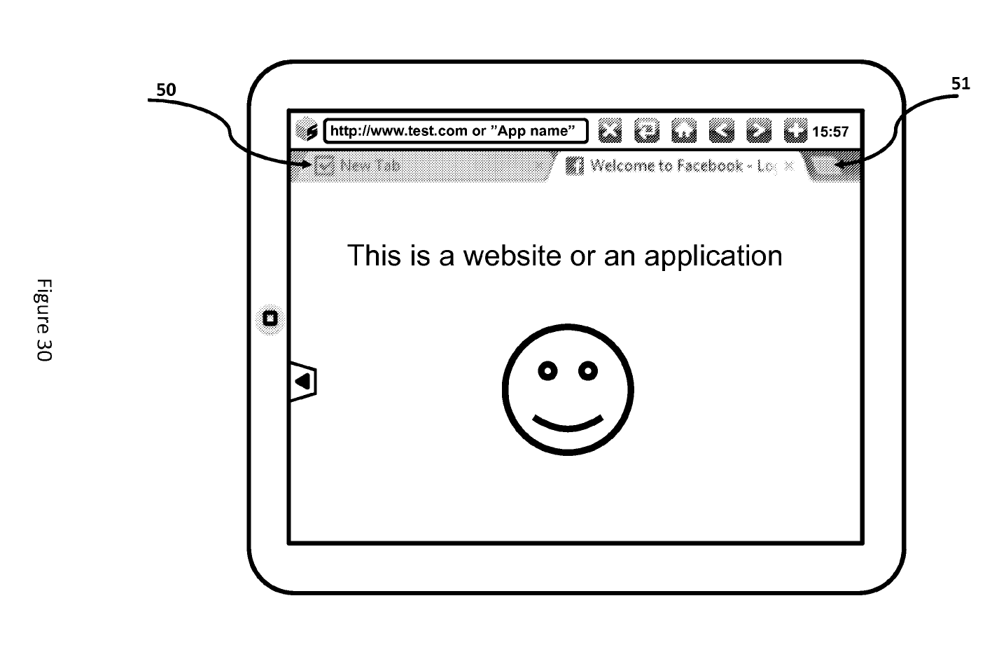

The interface has support for conventional tabbed browsing with session tabs, however the usage is extended to allow the user to multitask with tabs, as tabs can be either a website or an application. The user can switch between websites and applications as regular tabs in any other web browser without making any differentiation between remote internet content, stored offline website content, and local applications. Alternative settings allow tabs to be shown in different ways as illustrated by FIG. 28 (icon session tabs) and FIG. 30 (conventional session tabs). FIG. 29 illustrates what happens when the docking area 1 and category tabs 4 are revealed. The tabs can either be illustrated as regular tabs 50 or icon tabs 49 depending on the user's preferences.

Icon tabs 49 can as an additional example be expandable to show the active pages from the same website or the active application windows collated in for instance a drop down menu accessed by, for example, tapping and holding on the icon. If a user saved icon 15 exists for the website or application the icons in the tabs 49 get the same graphical icon as the previously saved one. If no saved icon exist the tab icon 49 will get the standard icon provided from the website (favicon). New tabs can be added by touching to the right 51 of the tabs 50 or in the icon example by touching or swiping in the clear area to the left of the icons 49.

If the session tabs fill the full width of the available space on the screen, the interface allows for the user to scroll horizontally as indicated by 48. Such an operation can be done for example by swiping or dragging or tapping the arrow tab.

### 7.5. Left & Right Handed Options

The interface allows for users to customize which side of the screen the docking area 1 shall be placed. This enables for both left and right handed users to use the interface comfortably.

### 7.6. In-Page Search

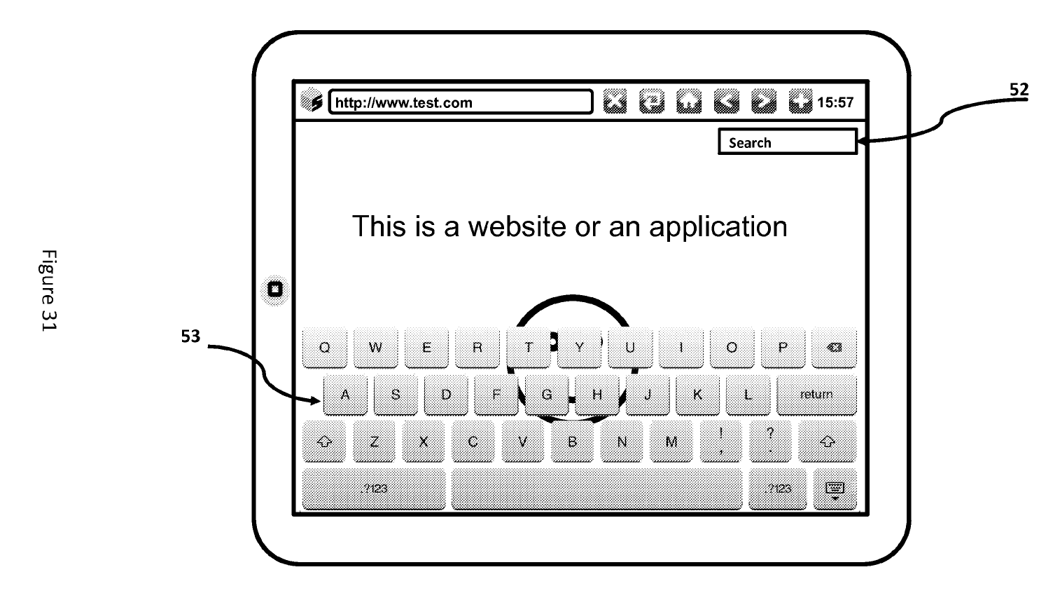

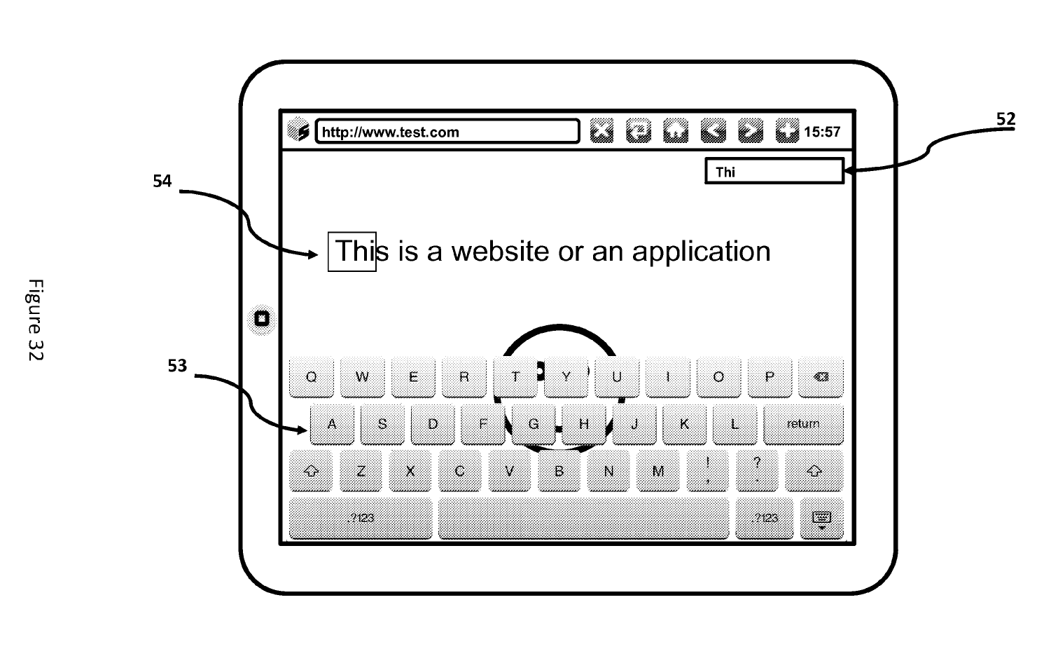

In-page search is illustrated e.g. in FIG. 31 and is designed to find text and other content, such as image descriptions, Meta data, code, descriptions, or any other content depending on settings, within a web page or application. The function is triggered from the settings menu, by a command by the user, or any other command well known in the art. This could for example include a combination of entries or touches, whereby the interface 14 displays the search box 52. The user can type a search string with for example a keyboard or on screen keyboard 53 whereby the system identifies, navigates to, and highlights 54 the results, as illustrated in FIG. 32.

### 7.7. Passcode Protection

The interface may allow for the user to passcode protect the interface. This can be done either to protect the entire interface, protect one user's session and user data, or as a separate feature to control parental control as described in section 7.10.

### 7.8. Multiple Accounts

The interface may have support for multiple user accounts, either for public or shared use. In one example the browser could be implemented in an advertisement showcase, in another the application could be applied in a bus for use by passengers during travel. Settings for privacy, parental control, and limitations are included and can be configured according to user preferences.

### 7.9. Ad-Blocking

The system can utilize both add-ins from third party developers as well as built in functions to solve problems normally addressed by add-ins. One example of this is ad-blocking allowing the interface to filter advertisement from the displayed content.

### 7.10. Parental Control

Parental Control allows for control content nature for a specific user of the device by limiting what they can access. This includes black and white lists for websites, websites containing specific words, and connections to filtered databases for the purpose. The parent, or administrator, can specify which degree of content can be shown on the device, if the user is allowed to enter information, for example post blogs or reply to instant messages.

### Section 8 Icons

All major web browsers have the facility for users to save a favourite (or bookmarked) website. These favourites typically are presented as a list of website names written in alpha numeric characters, plus (in some instances) a full URL web address and/or a mini icon or “favicon” (typically a 16×16 pixel image of a logo) incorporated into the wording. The favicons are predefined icons stored in a standardized way together with the website.

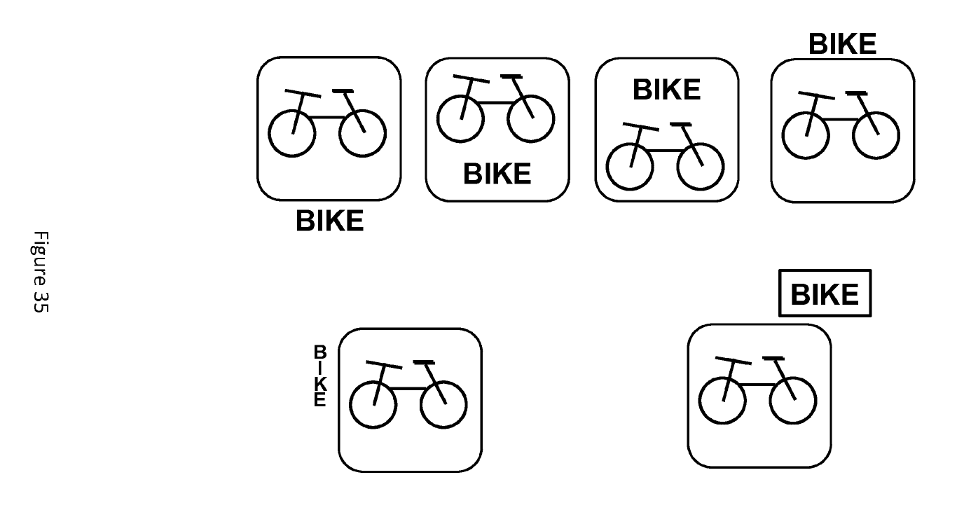

The icons 15 in the interface 14 take advantage of the ability of all humans to memorise and recognise images with an acuity many times greater than with conventional alphanumeric characters. By allowing the user to personalize an icon that they create 15 by selecting any image, the user can customize their browser experience and thus ease access of content by creating their own graphical icons 15 to represent favourite websites that can be categorised 4 and saved for future browsing. This functionality greatly improves and simplifies the representation of favourite websites and applications. Icons can be presented solely as images or images with associated text. The associated text can be shown in different ways including, beneath, over, above, at the side, or as a separate information box. Examples illustrating how the text could be presented are shown in FIG. 35.

### Section 9 Examples

### 9.1. Graphical User Interface

A general purpose computing device with a user operable graphical user interface comprising a browser area in which local applications and remotely stored websites are presented to the user in the same interface, where said websites and applications are shown in a web browser equivalent interface and the interface includes icons, links, or commands to open an application or navigate to a website. The following may also apply:
applications and websites are loaded/executed in the same browser area, without minimizing, closing, or opening a new window.
applications and websites are loaded/executed in co-existing session tabbed browser areas, without minimizing, closing, or opening a new window.
the user interface including one or multiple expandable panes/docking area for icons, links, or commands representing apps and/or websites.
the icons, links, or commands can be stored in selectable tabs sorted by category or in any other way for the convenience of or by the user.
the navigation history is agnostic to whether a website or application is shown to the user and the user can navigate back and forth between the history of pages and applications.
the links in the user interface, to websites or apps, are represented by user generated icons.
the user interface allows access to applications stored in the main operating system of the general purpose computer.
the user interface allows for installation and/or removal of applications.
tabs, pages, applications or similar are opened by swipes.

A general purpose computing device where the desktop application interface consists of a web browser interface with the capability to run applications in addition to browse the web, where said browser interface includes links to favourite websites and applications represented by icons. The following may also apply:
applications and websites are loaded/executed in the same window, without minimizing, closing, or opening a new window.
the user interface including an auto-hiding docking area for icons representing apps or websites.
the user interface allows access to applications stored in the main operating system of the general purpose computer.
the user interface allows for installation and/or removal of applications.
the links in the user interface, to websites or apps, are represented by icons.
the desktop application is the only graphical user interface on the device.
the graphical user interface is the only operating system on the device.
the user experience and display elements are the same independent of if the user opens a website or an application and where said websites and applications are represented as icons including user created content.
the user created content includes a picture, part of a picture, screen shot, part of a website, or other caption to be associated with the content.
the application is the only interface on the device or running as an application in another operating system.

### 9.2. Icons

A computer application that enables a user to define a graphical icon from a selected image on a website, a selection on a website, a screen shot, a picture, or from an icon library and associate said caption as the face of an icon. The following may also apply:
the icon is associated with a URL/website address and saved for future access.
the icon is saved and categorized by the user.
the icon is saved and later displayed in one of a plurality of category tabs in a web browser.
the user defines the icon as a part of the selected image.
the user defines the icon as an area of the image larger than the target size of the icon and the image is scaled to the predefined size of the icon.
the user defined image is rotated automatically or manually with the purpose of displaying it as the face of an icon.

The computer in any of the above is a computer with a touch-screen.

The computer in any of the above is a tablet computer.

The application in any of the above is the only interface on the device.

### 9.3. Sharing

An interface where a user shares content directly or through a server to other users using the same interface; wherein the shared content contains at least one user generated icon, icon set, or category tab. The following may also apply:
the user shares the content via social media, email, a blog, or any other electronic distribution channel.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Concepts

This document includes disclosure of multiple concepts A to D, listed below. Elements of the concepts may be combined.

### A. Method of Configuring Icons in a Web Browser Interface, and Associated Device and Computer Program Product.

There is provided a method of configuring icons in a web browser interface provided by a web browser program running on a computer, the computer including a memory storing applications, the method comprising the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface, and wherein the docking area is further operable to receive application icons, each application icon being selectable to run a respective application.

Further aspects of the method may include
each respective application is stored in the computer memory, the method further comprising the step that when run, each respective application provides output in the web browser interface.
when run, each respective application provides output in a full browser screen area excepting a pane.
the pane is at or near to a top of the screen.
anything a user would normally do within an operating system (“OS”) graphical user interface environment of the computer can be done within the web browser interface.
the web browser interface is pervasive.
the web browser interface is always-on.
the docking area is displayable integrally within the web browser interface.
the docking area is expandable to reveal hot link icons for all available applications and websites.
the icons are sized to be selectable with a fingertip when using a touch screen.
the web browser interface has expandable multiple docking areas within a browser window.
wherein the web browser interface includes multiple selectable icon category tabs.
icons are user-organisable into a plurality of categories, each category corresponding to an icon category tab.
a docking area and category tabs are operable to expand over an application screen output or a website screen output in response to user selection of an indication area, and to move back to a hidden position in response to user selection of an indication area.
icons are operable to be moved by the user by dragging them in to different positions in the docking area.
the web browser interface is operable to allow a user to customize which place on the screen the docking area is placed.
a place on the screen is a side of the screen, selectable to be either side of the screen.
web pages in websites are stored remotely from the computer.
the method including the step of providing a navigation history output in the web browser interface, wherein the navigation history includes previously selected website icons and previously selected application icons.
the method including the step of providing a back navigation icon, wherein selection of the back navigation icon selects a previously selected icon.
the method including the step of providing an icon-creation icon, wherein selection of the icon-creation icon when a website is displayed prompts a user to save the website and to choose a corresponding icon.
the corresponding icon is a library icon, a part of the displayed website, a part of a saved photo, or an icon identifiable by a search of the Web for a suitable icon.
icons corresponding to websites or applications are selectable for deletion from the docking area by dragging them away and dropping them in any other area of the web browser interface.
the web browser interface comprises an address field, the method including the step of presenting icons to the user in response to a text string entered by a user in the address field.
a set of icons in the docking area is operable to be distributed to other users.
the screen is a touch screen operable to receive touch screen input.
the web browser interface requires just two touches to either open any website or open any application with a corresponding icon in the docking area.

There is further provided a computer web browser program product operable when running on a computer to configure icons in a web browser interface provided by the program running on the computer, the computer including a memory storing applications, the computer web browser program product operable to perform the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface, and wherein the docking area is further operable to receive application icons, each application icon being selectable to run a respective application.

The computer web browser program product may be operable to perform any of the above method steps of concept A.

There is further provided a device comprising a processor, memory and a screen, the memory storing applications and a computer web browser program product, the processor configured to run the computer web browser program product, the program operable to configure icons in a web browser interface provided by the program running on the device, wherein the computer web browser program product

(i) provides screen output to the screen;
(ii) provides the web browser interface in the screen output;
(iii) provides in the web browser interface a docking area for icons,
wherein the docking area is operable to receive website icons, each website icon being selectable to navigate to a respective website in the web browser interface, and
wherein the docking area is further operable to receive application icons, each application icon being selectable to run a respective application on the device.

The device may be operable to perform any of the above method steps of concept A.

### B. Method of Sharing Icons in a Web Browser Interface, and Associated Device and Computer Program Product.

There is provided a method of sharing icons in a web browser interface provided by a web browser program running on a computer, the method comprising the steps of:

(i) providing screen output from the computer to a screen;
(ii) providing the web browser interface in the screen output;
wherein the web browser interface is operable to receive website icons, each website icon being selectable to navigate to a respective website in the web browser interface, and wherein the web browser interface is further operable to receive user input defining a set of icons for distribution to a set of users, and
(iii) distributing the set of icons to the set of users.

Further aspects of the method may include
(iv) providing in the web browser interface a docking area for icons, wherein the docking area is operable to receive website icons, each website icon being selectable to navigate to a respective website in the web browser interface.
set of users comprises a single user defined by user input
set of users comprises multiple users defined by user input
anything a user would normally do within an operating system (“OS”) graphical user interface environment of the computer can be done within the web browser interface.
the web browser interface is pervasive.
the web browser interface is always-on.
the docking area is displayable integrally within the web browser interface.
the icons are sized to be selectable with a fingertip when using a touch screen.
the web browser interface has expandable multiple docking areas within a browser window.
wherein the web browser interface includes multiple selectable icon category tabs.
icons are user-organisable into a plurality of categories, each category corresponding to an icon category tab.
a docking area and category tabs are operable to expand over a website screen output in response to user selection of an indication area, and to move back to a hidden position in response to user selection of an indication area.
icons are operable to be moved by the user by dragging them in to different positions in the docking area.
the web browser interface is operable to allow a user to customize which place on the screen the docking area is placed.
a place on the screen is a side of the screen, selectable to be either side of the screen.
web pages in websites are stored remotely from the computer.
the method including the step of providing a navigation history output in the web browser interface, wherein the navigation history includes previously selected website icons.
the method including the step of providing a back navigation icon, wherein selection of the back navigation icon selects a previously selected icon.
the method including the step of providing an icon-creation icon, wherein selection of the icon-creation icon when a website is displayed prompts a user to save the website and to choose a corresponding icon.
the corresponding icon is a library icon, a part of the displayed website, a part of a saved photo, or an icon identifiable by a search of the Web for a suitable icon.
icons corresponding to websites are selectable for deletion from the docking area by dragging them away and dropping them in any other area of the web browser interface.
the web browser interface comprises an address field, the method including the step of presenting icons to the user in response to a string entered by a user in the address field.
the screen is a touch screen operable to receive touch screen input.
the web browser interface requires just two touches to either open any website with a corresponding icon in the docking area.

There is further provided a computer web browser program product operable when running on a computer to share icons in a web browser interface provided by the program running on the computer, the computer web browser program product operable to perform the steps of:

(i) providing screen output from the computer to a screen;
(ii) providing the web browser interface in the screen output;
wherein the web browser interface is operable to receive website icons, each website icon being selectable to navigate to a respective website in the web browser interface, and wherein the web browser interface is further operable to receive user input defining a set of icons for distribution to a set of users, and
(iii) distributing the set of icons to the set of users.

The computer web browser program product may be operable to perform any of the above method steps of concept B.

There is further provided a device comprising a processor, memory and a screen, the memory storing a computer web browser program product, the processor configured to run the computer web browser program product, the program operable to share icons using a web browser interface provided by the program running on the device, wherein the computer web browser program product

(i) provides screen output to the screen;
(ii) provides the web browser interface in the screen output;
wherein the web browser interface is operable to receive website icons, each website icon being selectable to navigate to a respective website in the web browser interface, and wherein the web browser interface is further operable to receive user input defining a set of icons for distribution to a set of users, and
(iii) distributes the set of icons to the set of users.

The device may be operable to perform any of the above method steps of concept B.

### C. Method of Creating Icons in a Web Browser Interface, and Associated Device and Computer Program Product.

There is provided a method of creating icons in a web browser interface provided by a web browser program running on a computer, the method comprising the steps of:

(i) providing screen output from the computer to a screen;
(ii) providing the web browser interface in the screen output;
wherein the web browser interface is operable to receive website icons, each website icon being selectable to navigate to a respective website in the web browser interface, and
(iii) providing an icon-creation icon in the web browser interface, wherein selection of the icon-creation icon when a website is displayed prompts a user to save an icon corresponding to the website and to choose the corresponding icon.

Further aspects of the method may include
(iv) providing in the web browser interface a docking area for icons, wherein the docking area is operable to receive website icons, each website icon being selectable to navigate to a respective website in the web browser interface.
the corresponding icon is a library icon,
the corresponding icon is a part of the displayed website,
the corresponding icon is a part of a saved photo,
the corresponding icon is an icon identifiable by a search of the Web for a suitable icon.
the web browser interface is pervasive.
the web browser interface is always-on.
the docking area is displayable integrally within the web browser interface.
the docking area is expandable to reveal hot link icons for all available applications and websites.
the icons are sized to be selectable with a fingertip when using a touch screen.
the web browser interface has expandable multiple docking areas within a browser window.
wherein the web browser interface includes multiple selectable icon category tabs.
icons are user-organisable into a plurality of categories, each category corresponding to an icon category tab.
a docking area and category tabs are operable to expand over a website screen output in response to user selection of an indication area, and to move back to a hidden position in response to user selection of an indication area.
icons are operable to be moved by the user by dragging them in to different positions in the docking area.
the web browser interface is operable to allow a user to customize which place on the screen the docking area is placed.
a place on the screen is a side of the screen, selectable to be either side of the screen.
web pages in websites are stored remotely from the computer.
the method including the step of providing a navigation history output in the web browser interface, wherein the navigation history includes previously selected website icons.
the method including the step of providing a back navigation icon, wherein selection of the back navigation icon selects a previously selected icon.
icons corresponding to websites or applications are selectable for deletion from the docking area by dragging them away and dropping them in any other area of the web browser interface.
the web browser interface comprises an address field, the method including the step of presenting icons to the user in response to a string entered by a user in the address field.
a set of icons in the docking area is operable to be distributed to other users.
the screen is a touch screen operable to receive touch screen input.
the web browser interface requires just two touches to either open any website or open any application with a corresponding icon in the docking area.

There is further provided a computer web browser program product operable when running on a computer to create icons in a web browser interface provided by the program running on the computer, the computer web browser program product operable to perform the steps of:

(i) providing screen output from the computer to a screen;
(ii) providing the web browser interface in the screen output;
wherein the web browser interface is operable to receive website icons, each website icon being selectable to navigate to a respective website in the web browser interface, and
(iii) providing an icon-creation icon in the web browser interface, wherein selection of the icon-creation icon when a website is displayed prompts a user to save an icon corresponding to the website and to choose the corresponding icon.

The computer web browser program product may be operable to perform any of the above method steps of concept C.

There is further provided a device comprising a processor, memory and a screen, the memory storing a computer web browser program product, the processor configured to run the computer web browser program product, the program operable to create icons in a web browser interface provided by the program running on the device, wherein the computer web browser program product

(i) provides screen output to the screen;
(ii) provides the web browser interface in the screen output;
wherein the web browser interface is operable to receive website icons, each website icon being selectable to navigate to a respective website in the web browser interface, and
(iii) provides an icon-creation icon in the web browser interface, wherein selection of the icon-creation icon when a website is displayed prompts a user to save an icon corresponding to the website and to choose the corresponding icon.

The device may be operable to perform any of the above method steps of concept C.

### D. Method of Configuring Icons in a Web Browser Interface, and Associated Device and Computer Program Product.

There is provided a method of configuring icons in a web browser interface provided by a web browser program running on a computer, the method comprising the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

Further aspects of the method may include
anything a user would normally do within an operating system (“OS”) graphical user interface environment of the computer can be done within the web browser interface.
the web browser interface is pervasive.
the web browser interface is always-on.
the docking area is displayable integrally within the web browser interface.
the docking area is expandable to reveal hot link icons for all available websites.
the icons are sized to be selectable with a fingertip when using a touch screen.
the web browser interface has expandable multiple docking areas within a browser window.
wherein the web browser interface includes multiple selectable icon category tabs.
icons are user-organisable into a plurality of categories, each category corresponding to an icon category tab.
a docking area and category tabs are operable to expand over a website screen output in response to user selection of an indication area, and to move back to a hidden position in response to user selection of an indication area.
icons are operable to be moved by the user by dragging them in to different positions in the docking area.
the web browser interface is operable to allow a user to customize which place on the screen the docking area is placed.
a place on the screen is a side of the screen, selectable to be either side of the screen.
web pages in websites are stored remotely from the computer.
the method including the step of providing a navigation history output in the web browser interface, wherein the navigation history includes previously selected website icons.
the method including the step of providing a back navigation icon, wherein selection of the back navigation icon selects a previously selected icon.
the method including the step of providing an icon-creation icon, wherein selection of the icon-creation icon when a website is displayed prompts a user to save the website and to choose a corresponding icon.
the corresponding icon is a library icon, a part of the displayed website, a part of a saved photo, or an icon identifiable by a search of the Web for a suitable icon.
icons corresponding to websites or applications are selectable for deletion from the docking area by dragging them away and dropping them in any other area of the web browser interface.
the web browser interface comprises an address field, the method including the step of presenting icons to the user in response to a string entered by a user in the address field.
a set of icons in the docking area is operable to be distributed to other users.
the screen is a touch screen operable to receive touch screen input.
the web browser interface requires just two touches to either open any website or open any application with a corresponding icon in the docking area.

There is further provided a computer web browser program product operable when running on a computer to configure icons in a web browser interface provided by the program running on the computer, the computer including a memory storing the computer web browser program product operable to perform the steps of:

(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

The computer web browser program product may be operable to perform any of the above method steps of concept D.

There is further provided a device comprising a processor, memory and a screen, the memory storing a computer web browser program product, the processor configured to run the computer web browser program product, the program operable to configure icons in a web browser interface provided by the program running on the device, wherein the computer web browser program product

(i) provides screen output to the screen;
(ii) provides the web browser interface in the screen output;
(iii) provides in the web browser interface a docking area for icons,
wherein the docking area is operable to receive website icons, each website icon being selectable to navigate to a respective website in the web browser interface.

The device may be operable to perform any of the above method steps of concept D.

1. A method of configuring icons in a web browser interface provided by a web browser program running on a computer, the method comprising the steps of:
(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

2. The method of claim 1, the method further comprising a method of creating icons in a web browser interface provided by a web browser program running on a computer, the method further comprising the steps of:
(iv) providing an icon-creation icon in the web browser interface, wherein selection of the icon-creation icon when a website is displayed prompts a user to save an icon corresponding to the website and to choose the corresponding icon.

3. The method of claim 2, wherein the corresponding icon is a library icon.

4. The method of claim 2, wherein the corresponding icon is a part of a saved photo.

5. The method of claim 2, wherein the corresponding icon is an icon identifiable by a search of the Web for a suitable icon.

6. The method of claim 2, wherein the corresponding icon is a part of the displayed website.

7. The method of claim 6, wherein the corresponding icon is a user-selected portion of a web page.

8. The method of claim 6, wherein the corresponding icon is a user-selectable re-sizeable region of a web page.

9. The method of claim 6, wherein the corresponding icon is a square or rectangular icon including any text, graphics or images present in a region of a web page.

10. The method of claim 1, wherein anything a user would normally do within an operating system (“OS”) graphical user interface environment of the computer can be done within the web browser interface.

11. The method of claim 1, wherein the web browser interface is pervasive.

12. The method of claim 1, wherein the web browser interface is always-on.

13. The method of claim 1, wherein the docking area is displayable integrally within the web browser interface.

14. The method of claim 1, wherein the docking area is expandable to reveal hot link icons for all available websites.

15. The method of claim 1, wherein the docking area icons are sized to be selectable with a fingertip when using a touch screen.

16. The method of claim 1, wherein the web browser interface has expandable multiple docking areas within a browser window.

17. The method of claim 1, wherein the web browser interface includes multiple selectable icon category tabs.

18. The method of claim 1, wherein docking area icons are user-organisable into a plurality of categories, each category corresponding to an icon category tab.

19. The method of claim 1, wherein a docking area and category tabs are operable to expand over a website screen output in response to user selection of an indication area, and to move back to a hidden position in response to user selection of an indication area.

20. The method of claim 1, wherein docking area icons are operable to be moved by the user by dragging them in to different positions in the docking area.

21. The method of claim 1, wherein the web browser interface is operable to allow a user to customize which place on the screen the docking area is placed.

22. The method of claim 21, wherein a place on the screen is a side of the screen, selectable to be either side of the screen.

23. The method of claim 1, wherein web pages in websites are stored remotely from the computer.

24. The method of claim 1, the method including the step of providing a navigation history output in the web browser interface, wherein the navigation history includes previously selected website icons.

25. The method of claim 1, the method including the step of providing a back navigation icon, wherein selection of the back navigation icon selects a previously selected icon.

26. The method of claim 1, wherein icons corresponding to websites are selectable for deletion from the docking area by dragging them away and dropping them in any other area of the web browser interface.

27. The method of claim 1, wherein the web browser interface comprises an address field, the method including the step of presenting docking area icons to the user in response to a string entered by a user in the address field.

28. The method of claim 1, wherein a set of icons in the docking area is operable to be distributed to other users.

29. The method of claim 1, wherein the screen is a touch screen operable to receive touch screen input.

30. The method of claim 29, wherein the web browser interface requires just two touches to either open any website or open any application with a corresponding icon in the docking area.

31. A computer web browser program product operable when running on a computer to configure icons in a web browser interface provided by the program running on the computer, the computer including a memory storing the computer web browser program product operable to perform the steps of:
(i) providing screen output from the computer to a screen;
(ii) providing the web browser interface in the screen output;
(iii) providing in the web browser interface a docking area for icons,
wherein the docking area is operable to receive website icons, each website icon being selectable to navigate to a respective website in the web browser interface.

31. (canceled)

32. A device comprising a processor, memory and a screen, the memory storing a computer web browser program product, the processor configured to run the computer web browser program product, the program operable to configure icons in a web browser interface provided by the program running on the device, wherein the computer web browser program product
(i) provides screen output to the screen;
(ii) provides the web browser interface in the screen output;
(iii) provides in the web browser interface a docking area for icons,
wherein the docking area is operable to receive website icons, each website icon being selectable to navigate to a respective website in the web browser interface.

33. (canceled)
